(19) United States
(12) Patent Application Publication
(10) Pub. No.: US 2026/0261324 A1
(43) Pub. Date: Sep. 3, 2026

(54) A TECHNIQUE FOR SPATIAL PRECODING

(71) Applicant: Telefonaktiebolaget LM Ericsson (publ), Stockholm (SE)

(72) Inventors: Fehmi Emre KADAN, Istanbul (TR); Ömer HALILOGLU, Istanbul (TR)

(73) Assignee: Telefonaktiebolaget LM Ericsson (publ), Stockholm (SE)

(21) Appl. No.: 19/162,949

(22) PCT Filed: Mar. 10, 2023
(86) PCT No.: PCT/TR2023/050240

§ 371 Date: Sep. 7, 2025

(51) Int. Cl. H04B 7/06; H04B 7/0413; H04L 5/00

(52) U.S. Cl. CPC H04B 7/0697; H04B 7/0413; H04L 5/0044

(57) ABSTRACT

As to a method aspect, which is performed by a radio unit, RU (100), of a radio access network, RAN, a report message is sent to a central unit, CU, of the RAN. The report message is indicative of a priority value for each of one or more reported spatial layers towards at least one radio device (502). A control message is received from the CU. The control message is indicative of zero or more selected spatial layers towards the at least one radio device (502), wherein the zero or more selected spatial layers are a subset of the one or more reported spatial layers.

The present disclosure relates to a precoding technique, especially for uplink-aided frequency division duplex networks. More specifically, and without limitation, methods and devices are provided for uplink-aided precoding of a frequency division duplex radio communication at multiple-input multiple-output radio units.

### BACKGROUND

The Frequency Division Duplexing (FDD) mode is widely used in current cellular communication systems because of its latency can be less compared to the Time-Division Duplex (TDD) mode. However, due to the use of different frequencies in the uplink and downlink in FDD, the channel coefficients obtained in the uplink cannot be directly used in the downlink at the base station side.

Fifth generation New Radio (5G NR) is a radio access technology (RAT) specified by the Third Generation Partnership Project (3GPP). According to 5G NR, a radio access network (RAN) performs codebook-based beamforming in FDD mode, for which channel estimation is performed at radio devices and fed back to the RAN. The process starts with the transmission of beamformed pilots from a base station (e.g. a gNodeB) of the RAN to the radio devices (e.g., user equipments, UEs). Each UE estimates its channel using the downlink pilots and finds the closest element of the codebook. The UEs then transmit a corresponding index of the codebook (referred to as the precoding matrix indicator, PMI) to the base station in the uplink so that the channel information is obtained at the base station side. This process is called training and is followed to obtain the downlink channel at the base station side. Due to the limited size of the codebook, only a partial channel knowledge can be obtained by the base stations, which limits the interference elimination capabilities. In addition, the training process causes a large overhead as multiple downlink and uplink slots are required for the pilots and feedback, respectively.

5G NR systems use massive multiple-input multiple-output (MIMO) radio channels for enhanced network coverage and capacity. Since FDD is the predominant mode of operation, it is important to address the challenges for massive MIMO systems in FDD mode. One such challenge is the downlink channel estimation, which should be achieved with minimal pilot and feedback overhead. There exist mainly three conventional techniques for uplink-aided channel estimation in FDD mode (which is briefly referred to as uplink-aided FDD). Each conventional technique has some drawbacks as explained below, and a better method is required.

A first conventional methods requires M×K×P downlink resources to complete the training, wherein P is the total number of dominant paths for uplink and/or downlink transmission, M is the total number of radio units (RUs) of the RAN that cooperatively serve a number of K radio devices. Distributed MIMO (D-MIMO) typically has many RUs, and hence, M is large. Therefore, the channel estimation overhead for the conventional method is very large. For example, considering an outdoor scenario with frequency selective and time-varying channels, a typical coherence block length value assumed in the literature is 200. Assuming a number of 16 RUs, a number of 8 UEs and 2 dominant paths, there is a need for M×K×P=256 time-frequency grid-points for transmitting downlink pilots. In this scenario, it is impossible to obtain the up-to-date full channel state information as M×K×P is larger than the channel coherence block length.

A second conventional method by Y. Han, T. Hsu, C. Wen, K. Wong and S. Jin, “Efficient Downlink Channel Reconstruction for FDD Multi-Antenna Systems,” in IEEE Transactions on Wireless Communications, vol. 18, no. 6, pp. 3161-3176 June 2019, was originally proposed for collocated massive MIMO and corresponds to a degenerate case of D-MIMO with M=1 RU. It requires the transmission of angular and delay parameters to radio devices. For a typical D-MIMO setup, M is large, hence different angle and delay parameters have to be transmitted to each radio device from each RU. Since the angle and delay parameters of different RUs will be different, this method becomes impractical for D-MIMO.

A third conventional method by A. Abdallah and M. M. Mansour, “Efficient Angle-Domain Processing for FDD-Based Cell-Free Massive MIMO Systems,” in IEEE Transactions on Communications, vol. 68, no. 4, pp. 2188-223 April 2020 uses angle and delay information obtained in the uplink to generate precoders. Although it does not require a training phase, the limited information about the channels results in a reduced performance.

In summary, the method by Y. Han, T. Hsu, C. Wen, K. Wong and S. Jin, “Efficient Downlink Channel Reconstruction for FDD Multi-Antenna Systems,” in IEEE Transactions on Wireless Communications, vol. 18, no. 6, pp. 3161-3176 June 2019 is proposed for collocated massive MIMO and it is impractical for D-MIMO. The conventional method can obtain the complete channel knowledge, but suffers from the large training overhead. The method in “Efficient Angle-Domain Processing for FDD-Based Cell-Free Massive MIMO Systems” completely eliminates the training phase at the expense of a significant performance reduction.

As a result, there is a need for a technique that includes some training phase to obtain the necessary channel gain information about the downlink channels, wherein the training structure has to be designed to reduce its overhead.

### SUMMARY

As to a first method aspect, a method performed by a radio unit (RU) of a radio access network (RAN) is provided. The method comprises or initiates the step of sending a report message to a central unit (CU) of the RAN. The report message is indicative of a priority value for each of one or more reported spatial layers towards at least one radio device. The method further comprises or initiates the step of receiving a control message from the central unit. The control message is indicative of zero or more selected spatial layers towards the at least one radio device. The zero or more selected spatial layers are a subset of the one or more reported spatial layers.

By indicating the zero or more selected spatial layers, the training complexity, e.g. the number of radio resources, for determining the downlink channel information can become independent of the number of RUs at least in some network scenarios, e.g. in D-MIMO scenarios or asymptotically for a large number of RUs.

The one or more spatial layers may be referred to as the at least one spatial layer. The zero or more selected spatial layers may be referred to as the subset of the at least one spatial layer.

The report message may be indicative of the priority value in association with each of the one or more spatial layers towards at least one radio device. That is, the report message may be indicative of the priority value for each combination of the at least one radio device and the at least one spatial layer towards the respective radio device.

The CU may be implemented by or located in the RAN. Alternatively or more specifically, the CU may be implemented or located by one of the RUs of the RAN or a dedicated node, e.g. a node of a fronthaul network or a backhaul network for the RAN. Alternatively or in addition, the CU may be implemented by or located in a core network (CN) supporting the RAN, or by means of networked servers (e.g. cloud computing).

The radio device may be also referred to as a user equipment (UE), e.g. according to a 3GPP specification. The radio device may be in radio communication with and/or served by the at least one RU.

The RU may encompass a network node (e.g. RAN node, wireless access point, AP, or base station of the RAN), a radio head, or a distributed unit (DU) of a split architecture for network nodes. The RU may be also referred to as a network node or a base station, e.g., that may be in radio communication with the at least one radio device. The RU may be further in communication with a core node or core network (CN), e.g., implementing the CU.

The CU may be in communication (e.g., via wire and/or wireless communication) with the RU (or each of the RUs) of the RAN. The CU may be part of the core node (CN) and/or the RU (or one of the RUs) of the RAN. Since the CU is connected to at least two RUs of the RAN, the CU may be referred to as a central processor (CP) of the RAN. The central unit (CU) may or may not coincide with a centralized unit (sometime also abbreviated by CU) of the split architecture for network nodes.

The RU (or each of the RUs of the RAN) may have multiple antennas (e.g., a number of L antennas). The at least one radio device may have a few or a single antenna (wherein the latter may also be referred to as MISO as a special case of MIMO).

The spatial layers may be referred to as candidate beams or candidate paths towards the at least one radio device. Alternatively or in addition, the one or more spatial layers, for each of which the priority is reported in the report message, may also be referred to as the one or more reported spatial layers (which may not require that vectors of the layers are reported). The one or more reported layers (i.e., the one or more candidate beams or candidate paths) may be referred to as candidates. Alternatively or in addition, the selected spatial layers may be referred to as selected beams or selected paths. For example, the RU may comprise a plurality of antennas (e.g., antenna ports or antenna elements of an antenna system). Each (e.g., reported or selected) spatial layer may correspond to a precoding vector (e.g., at the respectively reporting RU). For example, each element of the precoding vector may correspond to a complex-valued gain associated with one of the antennas.

The (e.g., reported or selected) spatial layers may or may not correspond to dominant paths (i.e., isolated paths or paths with disjoint beamforming directions), e.g. as a result of an orthogonalization of the precoding vectors. For example, the (e.g., reported or selected) spatial layers may correspond to a linear combination of two or more dominant paths (also referred to as the physical beams) from the RU.

The report message (e.g., according to the first method aspect) may be indicative of each of the at least one radio device in association with each of the one or more reported spatial layers towards the at least one radio device.

By being indicative of the at least one radio device, the report message can enable the CU of the RAN to select (i.e., to down-select) the best spatial layers (e.g., P best spatial layers) for each radio device served by (e.g., wirelessly connected to) the RAN. For example, the report message may comprise an identifier of each of the at least one radio device. The identifier may uniquely identify each radio device (e.g., at least of the RAN). Since there may be at least two RUs of the RAN, one RU performing the first method aspect may be selected (according to the received control message) to provide radio access in none or a proper subset of the P best spatial layers of the respectively indicated radio device.

The RAN (e.g., according to the first method aspect) may comprise a plurality of RUs, e.g. for distributed multiple-input multiple-output (D-MIMO) in the downlink (DL) to the at least one radio device.

The RAN may comprise at least two RUs. For example, if the control message received by one of the RUs is indicative of zero selected spatial layers for the at least one radio device, this may imply that the at least one radio device is being served by another one of the RUs.

The RAN may serve (e.g., provide radio access to) at least two radio devices (including the at least one radio device) according to multi-user MIMO (MU-MIMO), e.g., MU-MISO.

The RAN may provide D-MIMO, which may also be referred to as network MIMO. The technique may be distinct from collocated massive MIMO (e.g., in legacy 5G networks) or a single RU providing MIMO or each RU independently performing beam steering or spatial precoding. Alternatively or in addition, embodiments of the subject technique may extend the concept of MIMO from a single RU to at least two RUs working in cooperation to provide enhanced radio coverage and improved channel capacity. Embodiments of the technique can provide advantages of D-MIMO such as improved coverage, capacity, and quality of service (QoS) for radio devices with less inter-path interference, less energy consumption by the RAN, and/or improved spectral efficiency due to the down-selection of spatial layers in the control message from the central unit compared to existing D-MIMO systems.

In a typical D-MIMO, there is a large number of RUs, e.g., a number of M RUs, M>>1. In D-MIMO the total numbers of antennas of all RUs may be greater than the total number of radio devices jointly served within the same time and/or frequency resource block.

The method (e.g., according to the first method aspect) may further comprise or initiate receiving an uplink (UL) pilot signal from the at least one radio device.

The UL pilot signal may comprise one or more UL reference signals. E.g., the UL pilot signal may comprise one or more sounding reference signals (SRSs). Moreover, pilot signals may also be referred to as pilots.

The method (e.g., according to the first method aspect) may further comprise or initiate determining the priority value for each of the one or more reported spatial layers towards the at least one radio device based on the UL pilot signal received from a respective one of the at least one radio device. Herein, the “respective one of the at least one radio” may refer to iteratively performing the method for each of the at least one radio.

The method (e.g., according to the first method aspect) may further comprise or initiate measuring at least one dominant path for each of the at least one radio device based on the UL pilot signal received from the respective one of the at least one radio device.

Each of the at least one dominant path may correspond to a beam direction of a radio beam at the RU towards the respective one of the at least one radio device (e.g., by measuring the beam direction), and/or a propagation delay of a radio propagation between the RU and the respective one of the at least one radio device (e.g., by measuring the propagation delay), and/or a path gain between the RU and the respective one of the at least one radio device (e.g., by measuring the path gain). Measuring the path gain may comprise measuring statistics of the path gain. The statistics may be used for determining the corresponding priority value of the spatial layer (i.e., the candidate beam).

The method (e.g., according to the first method aspect) may further comprise or initiate generating the one or more reported spatial layers. The one or more reported spatial layers may correspond to a linear combination of the measured one or more dominant paths. Alternatively or in addition, the priority value for each of the one or more reported spatial layers may be determined by the same linear combination, e.g. applied to a square (e.g., a square of the absolute value) of the path gain of the measured one or more dominant paths.

Generating the one or more (e.g., reported) spatial layers may comprise generating one or more spatial layers (i.e., candidate beams) based on UL information (e.g., the UL pilot signal) received from at least one radio device.

The (e.g., reported) spatial layers (i.e., candidate beams) and their priorities may be determined (i.e., generated) at the RU (or each of the RUs). Preferably, only the priority values (briefly: priorities) are sent to the CU. The priorities may be scalars, whereas the spatial layers itself may be represented by a complex-valued vector with dimension equal to the number of L antennas at the respective RU.

The number of the at least one dominant path (e.g. at the RU or per RU) may be more than one. The number of dominant paths may be measured by the RU (e.g., the one performing the first method aspect or by each of the at least two RUs in the RAN).

The RU may measure statistics of the path gain (e.g., the uplink channel gain statistics). The RU may use statistics to determine the priority value for each of the one or more reported spatial layers towards the at least one radio device. The statistics of the path gain may be, for example, a large-scale fading coefficients β_{m,k,p} of the path (e.g., a dominant path).

The beam direction and the propagation delay may be assumed as reciprocal. Furthermore, the uplink channel gain statistics and the downlink channel gain statistics may be assumed as reciprocal. The uplink channel gain and the downlink channel gain need not be reciprocal due to FDD.

Each of the one or more dominant paths may correspond to a precoding vector comprising an array steering vector (e.g., representing the beam direction and/or the propagation delay) and/or a complex channel gain (e.g., representing the path gain). Measuring the at least one dominant path in the uplink (e.g., for training or precoding a transmission in the downlink) may be referred to as uplink-aided (or uplink-assisted) spatial precoding.

The beam direction and/or the propagation delay and/or the path gain (e.g., the path gain statistics) may be referred to as path parameters (or beam parameters). The beam direction may comprise at least one of an azimuthal angle and an elevation (i.e., polar) angle. Measuring the one or more dominant paths may also be referred to as estimating the path parameters of the one or more dominant paths. The path parameters (e.g., the three parameters for the beam direction and the propagation delay) determined based on the UL pilot signal may be used for DL transmission due to partial channel reciprocity, e.g., for frequency-division duplexing (FDD).

Precoding vectors of the reported spatial layers (e.g., towards the same radio device and/or according to the first method aspect) may be orthogonal and/or normalized (e.g., orthonormal) as a result of the linear combination.

Orthonormality may be defined using a (e.g., standard) inner product on a complex vector space (e.g., the vector space of precoding vectors at the RU or complex coordinate space of dimension L).

Each of the one or more generated and/or reported spatial layers may correspond to an orthonormal complex-valued vector, e.g. based on and/or within a subspace of the respectively reporting RU (e.g., a beam subspace or linear subspace of the antenna system at the respectively reporting RU).

By way of example, the one or more generated and/or reported spatial layers may correspond to the P dominant paths for a first radio device. Thus, for M RUs, a number of M×P candidates may be generated and/or reported to the CU for the first radio device in total. For the one or more further radio devices, the number of candidates P_{C} may be less than P due to an orthonormality condition. By way of example, if a dominant path measured for the further radio device is in the linear subspace spanned by generated and/or reported candidates (i.e., precoding vectors) for the first radio device, no further candidate is generated and/or reported. The number of P_{C} candidates for a radio device may be even zero per RU. Therefore, the orthonormality condition may be understood as a condition to reduce the total number of dominant paths.

Alternatively or in addition, based on the orthonormality condition and/or the priority values, the total number of selected candidates per radio device may be reduced (e.g., limited or set) to P. For each radio device, a number of P dominant paths may be selected, i.e.,

$${\sum }_{m = 1}^{M} {J}_{m , k} = P$$

for each k, wherein k=1, . . . , K is the number of radio devices. Herein, J_{m,k} may be the number of selected candidates for the m-th RU and for the k-th radio device.

For each RU, all generated (and thus, all selected) candidate beams may be unit-norm as they are generated from orthonormal basis vectors of some subspaces and all generated candidate beams may be orthogonal to each other since each one is in the null-space of all previously generated beam vectors (i.e., the vectors of previously generated spatial layers).

Each RU may generate and/or report a (e.g., further) spatial layer if its total number of reported (or selected) spatial layers is less than P. Therefore, at least M×P spatial layers in total may be generated and/or reported. Considering that in total K×P spatial layers are needed in the RAN, M>K may be a sufficient condition for successfully selecting all necessary candidate beams. In a typical D-MIMO setup, M>>K, and hence, selecting candidate beams may be accomplished without a shortage of beam candidates and without a beam selection process getting stuck. In other words, there may be always at least one candidate beam.

Any precoding vector of the reported spatial layers towards a first radio device (e.g., according to the first method aspect) may be orthonormal to any precoding vector of the reported spatial layers towards a second radio device according to the (e.g., standard) inner product and/or as a result of the linear combination.

That is, subspaces spanned by precoding vectors of the reported spatial layers towards different radio devices may be orthonormal, e.g. according to the (e.g., standard) inner product and/or as a result of the linear combination used to generate the spatial layers.

The complex-valued path gain of the downlink may not be exactly equal to the complex-valued path gain of the uplink, therefore, there may be some chance of interference between downlink transmissions towards different radio devices or uplink receptions from different radio devices. According to the first method aspect, choosing (i.e. generating) orthogonal precoding vectors can increase the probability of eliminating the interference between different radio devices. In addition, choosing (i.e., generating) unit-norm precoders can simplify the generating (e.g., a computation) at the radio device (e.g., UE) in the downlink training stage. For example, each radio device may be configured to (e.g., simply) measure the downlink gain on the downlink pilots without any extra scaling operation.

The method (e.g., according to the first method aspect) may further comprise or initiate transmitting a downlink (DL) pilot signal to the at least one radio device using the at least one selected spatial layer received from the central unit. Alternatively or in addition, the method (e.g., according to the first method aspect) may further comprise or initiate refraining from transmitting to one of the at least one radio device if the received control message is indicative of no selected spatial layers towards the respective one of the at least one radio device (i.e., the case of zero selected spatial layers).

The DL pilot signal may comprise one or more DL reference signals. Alternatively or in addition, the DL pilot signal may comprise channel state information (CSI) reference signals.

The number of DL pilots sent to the at least one radio device may be considerably less than the number of pilots sent to the radio device in conventional D-MIMO trainings (e.g., the number can be M times less).

When the RU uses a (e.g., reported and selected) spatial layer for two or more radio devices, the RU may transmit a DL pilot signal using the selected spatial layer towards the at least two radio devices. The transmission of a DL pilot message may be referred to as the training phase. A subsequent data transmission may apply conventional scheduling to distinguish the at least two radio devices in the time and/or frequency domain.

Each of the at least one radio device may be enabled to measure (e.g., estimate) the complex-valued gains (e.g., DL path gains) of the one or more effective channels based on the DL pilot signals (e.g., based on DL pilot signals transmitted by the RU in the zero or more selected spatial layers, where no training occurs if zero spatial layers are selected) and feedback the related (e.g., measured or estimated) gains to the RAN, e.g., to the respective RU (e.g., in an uplink stage).

All of the signal processing (e.g., UL and/or DL signal processing) may be done locally at RUs, e.g. using local information only.

Subcarriers for receiving the UL pilot (e.g., according to the first method aspect) may be distinct or separated in the frequency domain from subcarriers for transmitting the DL pilot signal (e.g., according to the first method aspect) according to frequency division duplex (FDD).

Herein, “at least one of A, B, and C” may encompass A or B or C; or any subcombination of A, B, and C; or the combination of all of A, B, and C. Alternatively or in addition, “at least one of A, B, and C” may mean selected from the group of A, B, and C. Alternatively or in addition, “at least one of A, B, and C” may mean one or more of “A, B, and C”. Unless indicated otherwise, “at least one of A, B, and C” is not to be interpreted as meaning at least one of A, and at least one of B, and at least one of C, particularly not for units and preferably also not for categories. The same applies for using a semicolon (;) instead of a comma (,), as in above example. Furthermore, the above example illustrates the case of three items A, B, and C, while the same rule of interpretation is applicable to any number of items.

The method (e.g., according to the first method aspect) may further comprise or initiate receiving, from the at least one radio device, a channel state report based on the DL pilot signal. Optionally, the channel state report may comprise at least one of a measured DL gain of the one or more selected spatial layers; a precoding vector or precoding matrix of the one or more selected spatial layers; a codebook index for a precoding vector or precoding matrix of the one or more selected spatial layers; and a channel state information (CSI) report of the one or more selected spatial layers.

Herein, “one or more selected spatial layers” may refer to the second alternative of the “zero or more selected spatial layers”, because in the first alternative of “zero” selected spatial layers, no DL pilot signal is or needs to be transmitted.

Each radio device may be configured to measure the DL path gain of the corresponding effective channel. The one or more measured DL path gains may be quantized and fed back to the corresponding RU.

The RU may further determine DL path gain based on the received complex-valued channel gain measured by the at least one radio device.

Each radio device (e.g., the k-th radio device) may measure zero or more complex-valued channel gains

$$( e . g . {\{ {d}_{m , k , j} \}}_{j = 1}^{{J}_{m , k}} )$$

and feed this information back to the respective RU (e.g., the m-th RU). For the RAN, the training phase may use K×P downlink resources for transmitting the DL pilot signals, i.e. as P beamformed downlink pilots are transmitted for each radio device (e.g., UE). Each radio device may measure P complex gain values and sends the measured values back to respective RUs. Herein, complex-valued may be abbreviated by complex.

The method (e.g., according to the first method aspect) may further comprise or initiate the step of determining (e.g., computing) a DL precoder based on the channel state report received from the at least one radio device. The DL precoder may be, or may correspond to, a precoding vector.

The method (e.g., according to the first method aspect) may further comprise or initiate the step of transmitting payload data to the at least one radio device using a DL precoder (e.g., the above-mentioned DL precoder) based on the selected spatial layers received from the central unit and the channel state report received from the at least one radio device.

The selected beams (i.e., the selected spatial layers) may be transmitted from corresponding RUs using DL resources and DL pilots.

Embodiments of the precoding technique can significantly reduce the training overhead while maintaining high performance. The reduction may be based on orthonormal precoding vectors at each RU so that each precoder vector is an element of a range space formed by the array steering vectors of the corresponding RU.

The RU (e.g., according to the first method aspect) may be in radio communication with a plurality of radio devices. The steps of generating the reported spatial layers and/or determining the priority values for each of the reported spatial layers and/or sending the report message and/or receiving the selected spatial layers may be performed iteratively, e.g. for each of the radio devices in radio communication with the RU.

For example, the RU may generate and/or report spatial layers iteratively per radio device. In other words, in each report message there are priority values of the one or more spatial layers (i.e., candidate beams) of a single radio device. The selected spatial layer (i.e., the candidate beams selected by the CU) for one radio device may affect the one or more generated and/or reported spatial layers (i.e., candidate beams) of the next radio device. Because of this dependency, each of the report messages may be sent and each of the control messages may be received iteratively for one radio device after the other.

The first method aspect may further comprise transmitting payload data to one of the at least one radio device. The payload data may transmitted using a weighted sum of the selected spatial layers towards the one radio device. Alternatively or in addition, the RU (i.e., the m-th RU) may transmit payload data precoded on the J_{m,k} selected spatial layers towards the one radio device (i.e., the k-th radio device). The weights or the precoding of the selected spatial layers (e.g., according to the first method aspect) may be based on (e.g., the RU receiving) at least one of: a signal-to-interference and noise ratio (SINR), a sounding reference signal (SRS), and channel state information (CSI).

As to a second method aspect, a method performed by a central unit (CU) of a radio access network (RAN) is provided. The method comprises or initiates the step of receiving a report message from at least two radio units (RUs) of the RAN. The report message is indicative of a priority value for each of one or more reported spatial layers towards at least one radio device. The method further comprises or initiates the step of sending a control message to each of the at least two RUs. The control message is indicative of zero or more selected spatial layers towards the at least one radio device. The zero or more selected spatial layers are a subset of the one or more reported spatial layers.

The second method aspect may further comprise any feature and/or any step disclosed in the context of the first method aspect, or a feature and/or step corresponding thereto, e.g., a receiver counterpart to a sender feature or step, and vice versa.

The CU may receive a report message from each of the at least two RUs. Alternatively or in addition, the at least two RUs may combine their reports indicative of the priority values for reported spatial layers towards the same radio device in one report message.

Each report message may be indicative of the one or more priority values of the one or more reported spatial layer towards a single one of the at least one radio device. These spatial layers may be referred to as reported spatial layers since their priority values are reported, and not necessarily because the vectors (e.g., beamforming or steering vectors) of these spatial layers are reported in the report message.

Each control message may be sent to one of the at least two RUs and may be indicative the zero or more selected spatial layer from the respective one of the at least two RUs towards a single one of the at least one radio device.

The CU may receive the priority values from at least one of the RUs for a plurality of radio devices. The report messages may be received and the control messages may be sent iteratively per radio device, i.e., in the case of a plurality of radio devices for one radio device after the other.

Herein, the priority values may also be referred to as beam priorities.

By receiving the priority values (i.e., the RUs share their knowledge of the determined beam priority) for at least one radio device at the CU, the CU may select (i.e., determine) the most prioritized beam (i.e., the reported spatial layers associated with the greatest priority values) for each radio device (i.e., per radio device).

The CU may be embodied by a node of the RAN. Alternatively or in addition, the CU may be part (e.g., a function or a node) of a core network (CN) associated with RAN.

Alternatively or in addition, the CU may (e.g., instead of the respectively reporting RU) determine the priority values. In this case, the CU may receive statistical UL information (e.g., the beam parameters) and/or information about an antenna array geometry for beamforming vectors (e.g., corresponding to the measured dominant paths) from the at least two RUs.

The method (e.g., according to the second method aspect) may further comprise or initiate a step of selecting zero or more spatial layers towards the at least one radio device from the received at least one priority value for each of the one or more reported spatial layers towards at least one radio device.

Since each report message may be indicative of the “priority value for each of one or more reported spatial layers” towards the at least one radio device, the CU may receive at least one priority value per radio device, which is referred to as “the received at least one priority value” in the selecting step.

In an embodiment, the only processing part that may be performed by the CU may be the step of selecting of the spatial layers (e.g., beam selection) from the candidate beams (i.e., from the reported spatial layers). Sending the determined beam priorities may require sending of a few priority values for the reported spatial layers (i.e., reported beams), e.g. over fronthaul links, which can be negligible.

The CU may select the zero or more spatial layers (also referred to as selected beams) for a radio device based on the received priority values (also referred to as beam priorities) from one or more RUs that are in communication with the at least one radio device. In other words, the CU has an overview information on all RUs and the radio devices in communications thereby, therefore the CU can apply a better beam selection. For instance, in case that a radio device is in communication with two RUs, the CU may select which one of RUs has better radio connectivity with the radio device and select the zero or more spatial layers for the RUs accordingly.

The CU may send a control message indicative of at least one selected spatial layers to the RU that had the better priority values for each of the one or more reported spatial layers towards one radio device, and may send a control message indicative of zero selected spatial layers to the one or more other RUs that did not have the better priority values for each of the one or more reported spatial layers towards at least one radio device. In other words the invention provides optimal connectivity with minimal interference for radio devices with optimal radio units. In an occasion that a new radio device enters the RAN, the CU may assign the best combination of radio unit and spatial layer (e.g., as indicated in terms of the priority value) to the new radio device in a shortest possible time. Alternatively or in addition, since the CU has an overview of all radio devices and RUs, the CU may assign the next (e.g., subsequently) best RU to a moving radio device (e.g., as a more dynamic handover in the context of D-MIMO) when the radio device moves within the RAN.

As to another aspect, a computer program product is provided. The computer program product comprises program code portions for performing any one of the steps of the first and/or second method aspect disclosed herein when the computer program product is executed by one or more computing devices. The computer program product may be stored on a computer-readable recording medium. The computer program product may also be provided for download, e.g., via the radio network, the RAN, the Internet and/or the host computer. Alternatively, or in addition, the method may be encoded in a Field-Programmable Gate Array (FPGA) and/or an Application-Specific Integrated Circuit (ASIC), or the functionality may be provided for download by means of a hardware description language.

As to a first device aspect, a radio unit (RU) of a radio access network (RAN) is provided. The RU comprises memory operable to store instructions and processing circuitry operable to execute the instructions, such that the RU is operable to send a report message to a central unit (CU) of the RAN. The report message is indicative of a priority value for each of one or more reported spatial layers towards at least one radio device. The RU is further operable to receive a control message from the CU. The control message is indicative of zero or more selected spatial layers towards the at least one radio device. The zero or more selected spatial layers are a subset of the one or more reported spatial layers.

The radio unit (e.g., according to the first device aspect) may further be operable to perform any one of the steps of the first method aspect.

As to another first device aspect, a radio unit (RU) of a radio access network (RAN) is provided. The RU is configured to send a report message to a central unit (CU) of the RAN. The report message is indicative of a priority value for each of one or more reported spatial layers towards at least one radio device. The RU is further configured to receive a control message from the CU. The control message is indicative of zero or more selected spatial layers towards the at least one radio device. The zero or more selected spatial layers are a subset of the one or more reported spatial layers.

The RU (e.g., according to the other first device aspect) may further be configured to perform any one of the steps of the first method aspect.

As to a second device aspect, a central unit (CU) configured to communicate with at least two radio units is provided. The CU comprising an interface and processing circuitry configured to receive a report message from at least two radio units (RU) of the RAN. The report message is indicative of a priority value for each of one or more reported spatial layers towards at least one radio device. The CU is further configured to send a control message to the radio unit. The control message is indicative of zero or more selected spatial layers towards the at least one radio device. The zero or more selected spatial layers are a subset of the one or more reported spatial layers.

The processing circuitry of the CU (e.g., according to the second device aspect) may be further configured to execute any one of the steps of the second method aspect.

As to a second device aspect, a central unit (CU) is provided. The CU comprises memory operable to store instructions and processing circuitry operable to execute the instructions, such that the CU is operable to receive a report message from at least two radio units (RUs) of the RAN. Each report message is indicative of a priority value for each of one or more reported spatial layers towards at least one radio device. The CU is further operable to send a control message to each of the at least two RUs. Each control message is indicative of zero or more selected spatial layers towards the at least one radio device. The zero or more selected spatial layers are a subset of the one or more reported spatial layers.

The CU (e.g., according to the second device aspect) may be configured to communicate with the at least two RUs.

The CU (e.g., according to the second device aspect) may further be operable to perform any one of the steps of second method aspect.

As to another second device aspect, a central unit (CU) is provided. The CU is configured to receive a report message from at least two radio units (RUs) of the RAN. The report message is indicative of a priority value for each of one or more reported spatial layers towards at least one radio device. The CU is further configured to send a control message to each of the at least two RUs. The control message is indicative of zero or more selected spatial layers towards the at least one radio device. The zero or more selected spatial layers are a subset of the one or more reported spatial layers.

The CU (e.g., according to the other second device aspect) may further be configured to perform any one of the steps of the second method aspect.

As to a system aspect, a system comprising at least two radio units (RUs) according to the first device aspect and at least one central unit (CU) according to second device aspect is provided.

Any one of the at least one radio device and/or any one of the RUs and/or the RAN may form, or may be part of, a radio network, e.g., according to the Third Generation Partnership Project (3GPP) or according to the standard family IEEE 802.11 (Wi-Fi). The first method aspect and the second method aspect may be performed by one or more embodiments of a RU (e.g., a base station) and a central unit (CU), respectively.

The RAN may comprise one or more RUs (e.g., base stations), e.g., performing the first method aspect. Alternatively or in addition, the radio network may be a vehicular, ad hoc and/or mesh network comprising two or more radio devices, e.g., acting as a remote radio device and/or a relay radio device.

Any of the radio devices may be a 3GPP user equipment (UE) or a Wi-Fi station (STA). The radio device may be a mobile or portable station, a device for machine-type communication (MTC), a device for narrowband Internet of Things (NB-IoT) or a combination thereof. Examples for the UE and the mobile station include a mobile phone, a tablet computer and a self-driving vehicle. Examples for the portable station include a laptop computer and a television set. Examples for the MTC device or the NB-IoT device include robots, sensors and/or actuators, e.g., in manufacturing, automotive communication and home automation. The MTC device or the NB-IoT device may be implemented in a manufacturing plant, household appliances and consumer electronics.

Whenever referring to the RAN, the RAN may be implemented by one or more RUs (e.g., base stations or distributed units for D-MIMO).

Any radio device may be wirelessly connected or connectable (e.g., according to a radio resource control, RRC, state or active mode) with any one of the RUs of the RAN.

The RU may encompass any station that is configured to provide radio access to any of the radio devices. The RUs may also be referred to as base stations, cell, transmission and reception point (TRP), radio access node or access point (AP). The RUs and/or the radio devices may provide a data link to a host computer providing the payload data (e.g. user data) to any one of the radio devices or gathering the payload data (e.g., user data) from any one of the radio devices. Examples for the base stations may include a 3G base station or Node B, 4G base station or eNodeB, a 5G base station or gNodeB, a Wi-Fi AP and a network controller (e.g., according to Bluetooth, ZigBee or Z-Wave).

The host computer may implement the CU.

The RAN may be implemented according to the Global System for Mobile Communications (GSM), the Universal Mobile Telecommunications System (UMTS), 3GPP Long Term Evolution (LTE) and/or 3GPP New Radio (NR).

Any aspect of the technique may be implemented on a Physical Layer (PHY), a Medium Access Control (MAC) layer, a Radio Link Control (RLC) layer, a packet data convergence protocol (PDCP) layer, and/or a Radio Resource Control (RRC) layer of a protocol stack for the radio communication.

Herein, referring to a protocol of a layer may also refer to the corresponding layer in the protocol stack. Vice versa, referring to a layer of the protocol stack may also refer to the corresponding protocol of the layer. Any protocol may be implemented by a corresponding method.

As to a still further aspect, a communication system including a host computer (e.g., an embodiment of the CU) is provided. The host computer comprises a processing circuitry configured to provide payload or user data. The host computer further comprises a communication interface configured to forward the data to a cellular network (e.g., an embodiment of the RAN and/or the RUs) for transmission to a UE (e.g., an embodiment of the radio devices). A processing circuitry of the cellular network is configured to execute any one of the steps of the first and/or second method aspects. Optionally, the UE comprises a radio interface and processing circuitry, which is configured to execute any one of the steps of the first and/or second method aspects.

The communication system may further include the UE. Alternatively, or in addition, the cellular network may further include one or more base stations (e.g., embodiments of the RUs) configured for radio communication with the UE and/or to provide a data link between the UE and the host computer using the first and/or second method aspects.

The processing circuitry of the host computer may be configured to perform the second method aspect.

Alternatively or in addition, the processing circuitry of the host computer may be configured to execute a host application, thereby providing the payload or user data and/or any host computer or CU functionality described herein. Alternatively, or in addition, the processing circuitry of the UE may be configured to execute a client application associated with the host application.

Any one of the devices, the UE, the base station, the communication system or any node or station for embodying the technique may further include any feature disclosed in the context of the method aspect, and vice versa. Particularly, any one of the units and modules disclosed herein may be configured to perform or initiate one or more of the steps of the method aspect.

### BRIEF DESCRIPTION OF THE DRAWINGS

Further details of embodiments of the technique are described with reference to the enclosed drawings, wherein:

FIG. 1 shows a schematic block diagram of an embodiment of a device for determining (e.g., training) a DL precoder;

FIG. 2 shows a schematic block diagram of an embodiment of a device for selecting spatial layers;

FIGS. 3A and 3B show a flowchart for a method of determining a DL precoder, which method may be implementable by the device of FIG. 1;

FIG. 4 shows a flowchart for a method of selecting spatial layers, which method may be implementable by the device of FIG. 2;

FIG. 5 schematically illustrates an example scenario of dominant paths and uplink-downlink reciprocity as to two angles and/or delay;

FIGS. 6A and 6B schematically illustrates a step of determining two angles and delay for uplink-assisted DL precoding, which may be performed in the method of FIGS. 3A and 3B or by the device of FIG. 1;

FIG. 7 shows an example D-MIMO setup schematically illustrating different angle and delay parameters for embodiments of the device of FIG. 1;

FIG. 8 shows a flowchart of an embodiment of the methods of FIGS. 3 and 4;

FIG. 9 schematically illustrates a block diagram (upper half) of embodiments of the devices of FIGS. 1 and 2, and a signaling diagram (lower half) resulting from embodiments of the methods of FIGS. 3A, 3B and 4.

FIG. 10 schematically illustrates an exemplary topology of a D-MIMO system comprising embodiments of the devices of FIGS. 1 and 2;

FIG. 11 shows a schematic signaling diagram resulting from embodiments of the devices of FIGS. 1 and 2 performing implementations of the methods of FIGS. 3A, 3B and 4;

FIG. 12 shows cumulative distribution functions (CDFs) of a spectral efficiency per UE for different prior art methods and method of FIGS. 3A to 3B;

FIG. 13 shows a schematic block diagram of a radio device embodying the device of FIG. 1;

FIG. 14 shows a schematic block diagram of a radio unit embodying the device of FIG. 2;

FIG. 15 schematically illustrates an example telecommunication network connected via an intermediate network to a host computer;

FIG. 16 shows a generalized block diagram of a host computer communicating via a base station or radio device functioning as a gateway with a user equipment over a partially wireless connection; and

FIGS. 17 and 18 show flowcharts for methods implemented in a communication system including a host computer, a base station or radio device functioning as a gateway and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR) or 5G implementation, it is readily apparent that the technique described herein may also be implemented for any other radio communication technique, including a Wireless Local Area Network (WLAN) implementation according to the standard family IEEE 802.11, 3GPP LTE (e.g., LTE-Advanced or a related radio access technique such as MulteFire), for Bluetooth according to the Bluetooth Special Interest Group (SIG), particularly Bluetooth Low Energy, Bluetooth Mesh Networking and Bluetooth broadcasting, for Z-Wave according to the Z-Wave Alliance or for ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

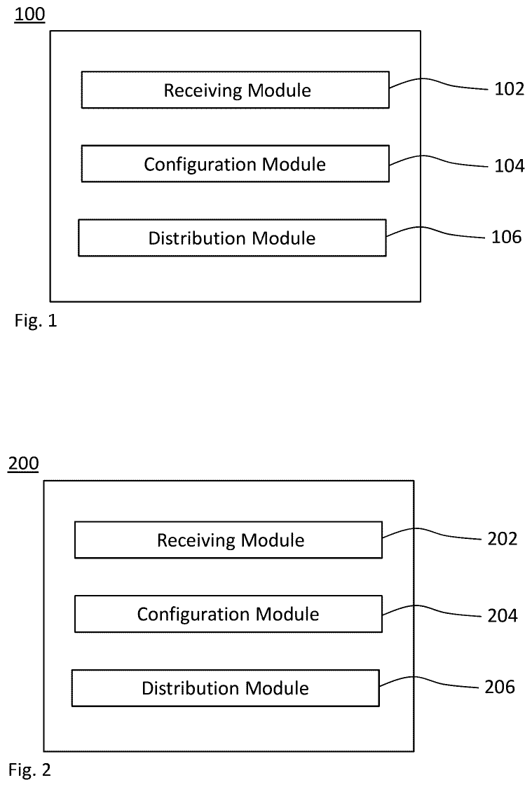

FIG. 1 schematically illustrates a block diagram of an embodiment of a device for determining (e.g., computing) a downlink (DL) precoder. The device is generically referred to by reference sign 100. The device 100 may be also referred to as radio unit and/or radio node and/or network node and/or base station. The radio unit 100 may be in a radio access network (RAN). The RAN may comprise plurality of radio units 100 for distributed MIMO (D-MIMO). The radio unit 100 may be in radio coverage or communication with zero or more radio devices 502. The radio unit 100 may be further in communication with a central unit 200 (e.g., wirelessly and/or via wire).

The radio unit 100 comprises a receiving module 102 that may be configured to receive an uplink (UL) pilot signal from at least one radio device 502. The receiving module 102 may be further configured to receive a control message from the central unit 200. The receiving module 102 may be further configured to receive a channel state report from the at least one radio device 502.

The radio unit 100 may further comprises a configuration module 104 in communication with any other modules of device 100. The configuration module 104 may be configured to determine a priority value for each of spatial layers towards the at least one radio devices 502 based on the received UL pilot signal from the respective one of the at least one radio device 502. The configuration module 104 may be further configured to measure at least one dominant paths for each of the at least one radio device 502 based on the received UL pilot signals from the respective one of the at least one radio device 502. The configuration module 104 may be further configured to generate the one or more reported spatial layers.

The radio unit 100 may further comprises a distribution module 106 that is configured to transmit a downlink (DL) pilot signal to the at least one radio device 502. The distribution module 106 may be further configured to refrain from transmitting to one of the at least one radio device 502 if the received control message is indicative of no selected spatial layers towards the respective one of the at least one radio device 502. The distribution module 106 may be further configured to transmit payload data to the at least one radio device 502 using the DL precoder.

Any of the modules of the device 100 may be implemented by units configured to provide the corresponding functionality.

The radio unit (RU) 100 may also be referred to as, or may be embodied by, a base station (e.g., a gNodeB). The RU 100 and the central unit (CU) may be in (wired or wireless) communication, e.g., at least for the sending of the report message and the receiving of the control message. The CU may be embodied by the below device 200.

FIG. 2 schematically illustrates a block diagram of an embodiment of a device for selecting spatial layers. The device is generically referred to by reference sign 200. The device 200 may be also referred to as central unit and/or central processor and/or core node. The central unit 200 may be implemented in a radio access network (RAN) or in a core network (CN). The RAN may comprise plurality of radio units for distributed MIMO. At least some or each of the radio units in the RAN may be an embodiment of the device 100. The central unit 200 may be in communication with one or at least two radio units 100. Alternatively or in addition, the central unit 200 may be part of one of the radio units 100 in the RAN.

The central unit 200 may comprise a receiving module 202 that may be configured to receive a report message from at least two radio units 100 of the RAN.

The central unit 200 may further comprise a configuration module 204 that may be configured to be in communication with any other modules of the central unit 200. The configuration module 204 may be configured to select zero or more spatial layers towards the at least one radio device 502 based on priority values received for each of the reported spatial layers towards at least one radio device 502.

The central unit 200 may further comprise a distribution module 206 that is configured to send a control message to the radio unit 100.

Any of the modules of the device 200 may be implemented by units configured to provide the corresponding functionality.

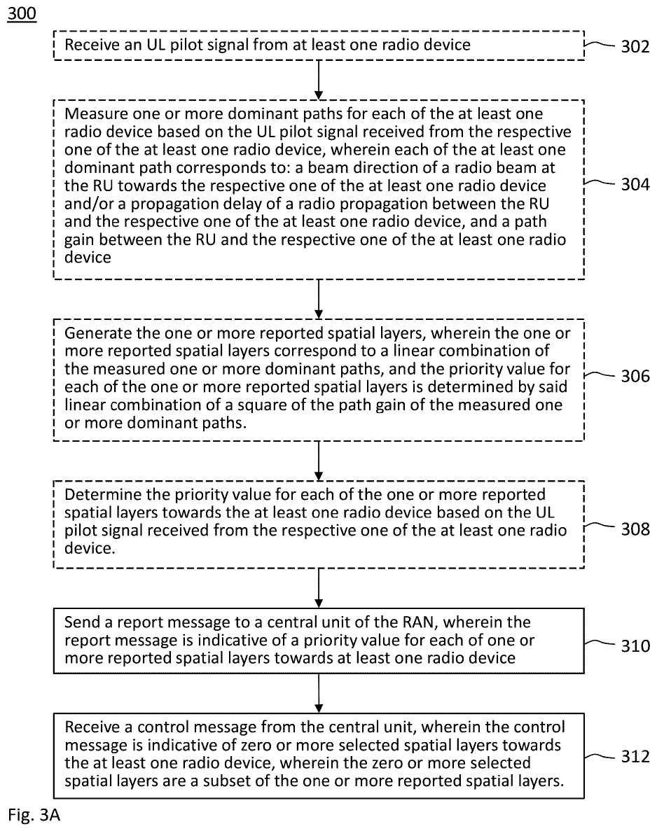

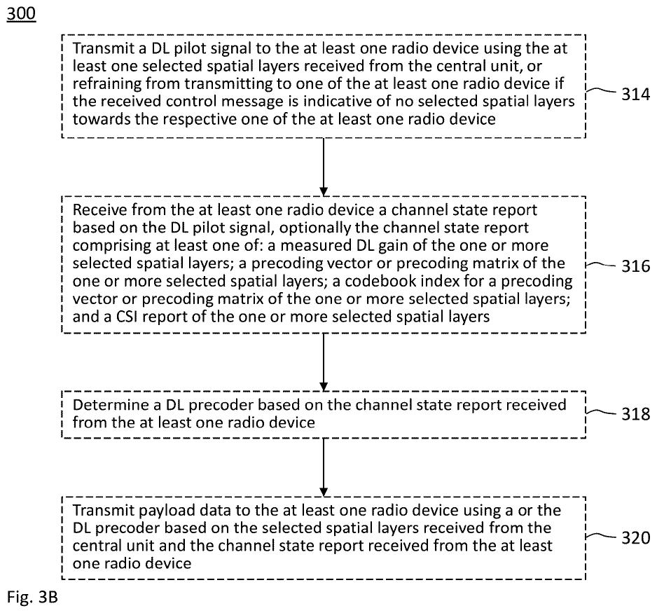

FIG. 3 shows an example flowchart for a method 300 performed by radio unit 100. Embodiments of the method 300 perform a precoding scheme that significantly reduces the training overhead while maintaining high performance.

In a step 310, the radio unit 100 may send a report message to a central unit 200 of the RAN. The message may be indicative of a priority value for each of one or more reported spatial layers towards at least one radio device 502.

In step 312, the radio unit 100 may receive a control message from the central unit 200. The control message may be indicative of zero or more selected spatial layers towards the at least one radio device 502. The zero or more selected spatial layers may be subset of one or more reported spatial layers.

Optionally in step 302, the radio unit 100 may receive uplink (UL) pilot signal from the at least one radio device 502.

Optionally in step 304, the radio unit 100 may measure at least one dominant path for each of the at least one radio device 502 based on the UL pilot signal received 302 from the respective one of the at least one radio device 502. Each of the at least one dominant path may correspond to a beam direction of a radio beam at the RU towards the respective one of the at least one radio device 502 and/or a propagation delay of a radio propagation between the RU and the respective one of the at least one radio device 502, and a path gain between the RU and the respective one of the at least one radio device 502.

Optionally in step 306, the radio unit 100 may generate the one or more reported spatial layers. The one or more reported spatial layers correspond to a linear combination of the measured 304 one or more dominant paths and a priority value for each of the one or more reported spatial layers.

Optionally in step 308, the radio unit 100 may determine the priority value for each of the one or more spatial layers toward the at least one radio device 502 based on the UL pilot signal received 302 from the respective one of the at least one radio device 502.

Optionally the priority value used in step 306 for each of the one or more reported spatial layers may be determined 308 by said linear combination of a square of the path gain of the measured 304 one or more dominant paths.

Optionally in step 314 for training the DL precoder, the radio unit 100 may transmit a downlink (DL) pilot signal to the at least one radio device 502 using the at least one selected spatial layer received 312 from the central unit 200. Optionally in step 314, the radio unit 100 may refrain from transmitting to one of the at least one radio device 502 if the received 312 control message is indicative of no selected spatial layers towards the respective one of the at least one radio device 502.

Optionally in step 316, the radio unit 100 may receive from the at least one radio device 502 a channel state report based on the DL pilot signal. Optionally the channel state report may comprise at least one of a measured DL gain of the one or more selected spatial layers; a precoding vector or precoding matrix of the one or more selected spatial layers; a codebook index for a precoding vector or precoding matrix of the one or more selected spatial layers; and a channel state information (CSI) report of the one or more selected spatial layers.

Optionally in step 318, the radio unit 100 may compute DL precoder based on the channel state report received 316 from the at least one radio device 502.

Optionally in step 320, the radio unit 100 may transmit payload data to the at least one radio device 502 using a or the DL precoder based on the selected spatial layers received 312 from the central unit 200 and the channel state report received 316 from the at least one radio device 502.

The method 300 may be performed by the device 100. For example, the module 102 may perform any one of the steps which require receiving from the radio device 502 and/or the central unit 200. The module 106 may perform any one of the steps which require transmitting to the radio device 502 and/or to the central unit 200. The module 104 may perform any other steps according to the method 300.

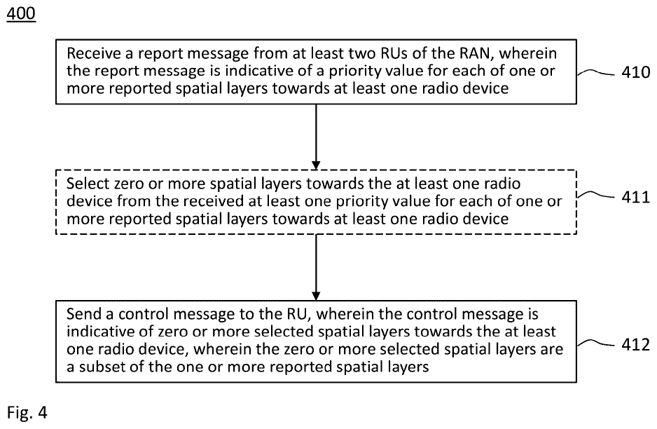

FIG. 4 shows an example flowchart for a method 400 performed by central unit 200. Embodiments of the method 400 can perform a selection scheme for a precoding process, which significantly reduces the training overhead while maintaining high performance.

In step 410 the central unit 200 may receive 410 a report message from at least two radio units 100 of the RAN. Each of the report messages may be indicative of a priority value for each of one or more reported spatial layers towards at least one radio device 502.

In step 412 the central unit 200 may sent a control message to the radio unit 100. The control message may be indicative of zero or more selected spatial layers towards the at least one radio device 502. The zero or more selected spatial layers may be a subset of the one or more reported spatial layers.

Optionally in step 411, the central unit 200 may select zero or more spatial layers towards the at least one radio device 502 from received at least one priority value for each of one or more reported spatial layers towards at least one radio device 502.

The method 400 may be performed by the device 200. For example, the module 202 may perform any one of the steps which require receiving from the radio units 100. The module 206 may perform any one of the steps which require transmitting to the radio units 100. The module 204 may perform any other steps according to the method 400.

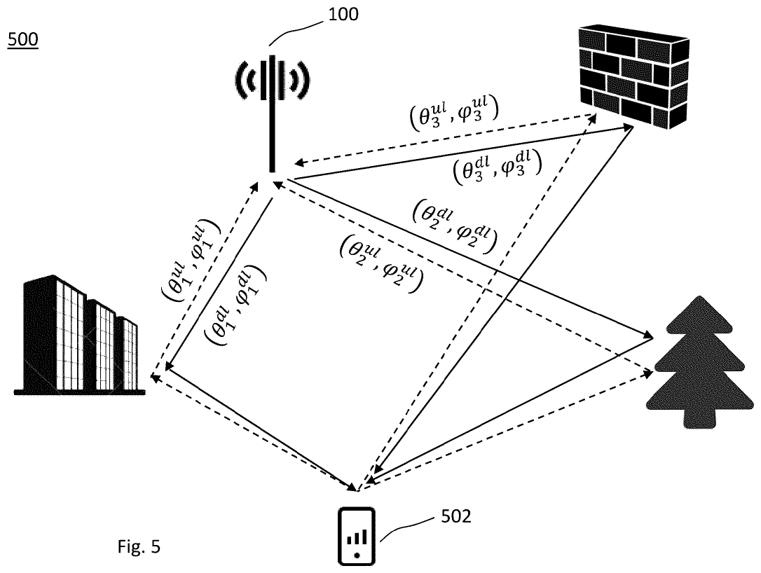

FIG. 5 schematically illustrates an example scenario showing the azimuth (?) and altitude (0) angle reciprocity and implicitly delay (t) of reciprocity for UL and DL transmission between a radio unit 100 and a radio device 502. These are examples of beam parameters that may be determined based on the UL pilots and used also for the DL precoder.

It is known that for a radio unit 100 (e.g., a remote radio unit) with L number of antennas and a radio device 502 with a single antenna, the UL and DL channels between these two devices (or nodes), measured at the radio unit side, can be formulated as:

$${h}_{ul , n} = {\sum }_{p = 1}^{{P}_{u l}} {c}_{p}^{u l} {e}^{j 2 π n Δ f {τ}_{p , ul}} a ( {θ}_{p , ul} , {φ}_{p , u l} ) \qquad ( 3 )$$

$${h}_{dl , n} = {\sum }_{p = 1}^{{P}_{d l}} {c}_{p}^{d l} {e}^{j 2 π ( Δ F + n Δ f ) {τ}_{p , dl}} a ( {θ}_{p , dl} , {φ}_{p , dl} ) \qquad ( 4 )$$

wherein h_{ul,n} and h_{dl,n} are two L×1 channel vectors, Pᵤₗ, P_{dl} are the number of dominant paths,

$${c}_{p}^{u l} , {c}_{p}^{d l}$$

are the complex channel gains, τ_{p,ul}, τ_{p,dl} are the delays for p-th path, θ_{p,ul}, θ_{p,dl} are the elevation and τ_{p,ul}, τ_{p,dl} are the azimuth angles for UL and DL, respectively. Here, the index n denotes the subcarrier index, Δf is the subcarrier frequency spacing, and ΔF is the frequency spacing between the DL and UL.

Although perfect channel reciprocity does not hold for FDD, some channel parameters of the UL and DL are reciprocal. Experimental results show that the angle and delay parameters in the UL and DL are highly correlated and can be assumed to be reciprocal, whereas the complex channel gains are generally different. It is also known that at high carrier frequencies, the number, P, of dominant paths becomes small and thus the channels are sparse. The sparsity and the reciprocity of angle and delay for the UL and DL have a significant potential to reduce the complexity of the DL channel estimation for FDD.

As shown in FIG. 5, there may be different scatterers and/or reflectors around the radio units 100 and the radio devices 502. The experiments show that the angle and/or delay parameters of these paths are similar for the UL and DL.

Considering the angle/delay reciprocity of the UL and DL, and shifting the subcarrier-dependent (index n is removed for simplicity in the formulae below) phase terms into the complex channel gains, we obtain the following channel representations:

$${h}_{m , k}^{u l} = {\sum }_{p = 1}^{P} {c}_{m , k , p}^{u l} {a}_{m , k , p}^{u l} \qquad ( 5 )$$

$${h}_{m , k}^{d l} = {\sum }_{p = 1}^{P} {c}_{m , k , p}^{d l} {a}_{m , k , p}^{d l} \qquad ( 6 )$$

Here,

$${h}_{m , k}^{u l} and {h}_{m , k}^{d l}$$

denotes the channel between radio unit m and radio device k,

$${c}_{m , k , p}^{ul} and {c}_{m , k , p}^{dl}$$

are complex channel gains for p-th path between m-th radio unit and k-th radio device, and

$${a}_{m , k , p}^{u l} and {a}_{m , k , p}^{d l}$$

are array steering vectors for the UL and DL, respectively. The dependency of the array steering vectors on the angle parameters has been suppressed for simplified notation. The natural number P is the total number of dominant paths, which is equal for both UL and DL.

The radio unit 100 may receive 302 an UL pilot signal (e.g., UL reference signal and/or sounding reference signal) from at least one radio device 502.

The radio unit 100 may measure (e.g., estimate) 304 the following information based on the received 302 UL pilot signal:
the number of dominant paths (P),
the angle/delay values of the dominant paths and hence the array steering vectors (a_{m,k,p}), and
the large-scale fading coefficients of the dominant paths (β_{m,k,p}), which may also be referred to as path gain statistics.

The information obtained in UL may provide P, a_{m,k,p} and β_{m,k,p} for all

$$m = 1 , 2 , … , M ,$$

$$k = 1 , 2 , … , K , and$$

$$p = 1 , 2 , … , P .$$

The DL channels may be represented as

$${h}_{m , k} = {\sum }_{p = 1}^{P} {c}_{m , k , p} {a}_{m , k , p} ,$$

Wherein [symbol] [|c_{m,k,p}|²]=β_{m,k,p}.

The estimation of parameters P, a_{m,k,p} and β_{m,k,p} in the UL stage may be done as proposed by A. Abdallah and M. M. Mansour, “Efficient Angle-Domain Processing for FDD-Based Cell-Free Massive MIMO Systems,” in IEEE Transactions on Communications, vol. 68, no. 4, pp. 2188-223 April 2020.

Once the angle and/or delay parameters have been measured using the received 302 UL pilot signals, the vectors

$${a}_{m , k , p}^{u l} and {a}_{m , k , p}^{d l}$$

can be constructed. The only unknowns at radio device 100 side for the DL channels are channel gains

$$( e . g . , {c}_{m , k , p}^{dl} ) .$$

To obtain the full channel knowledge, the radio unit 100 may transmit 314 some DL pilots to radio device 502 so that the channel gains can be estimated at radio device 502 side and received 316 by the radio units 100. In order to obtain the full information about DL channels, all

$${c}_{m , k , p}^{dl}$$

coefficients should be estimated by all the radio devices 502 and received 316 by radio units 100. This requires M×K×P DL resources (regardless of the number of radio unit 100 antennas), where M is the total number of radio units 100 cooperatively serving all K radio devices 502. As the corresponding training overhead becomes very large especially for large number of M radio units 100 (which is typical in D-MIMO), some techniques were proposed by method 300.

According to some prior art an UL-aided precoding design scheme for collocated massive MIMO has been proposed where the channel estimation is performed by estimating angle and delay parameters of radio device at radio unit using UL pilots. Then, the radio unit transmits these estimated parameters to radio devices in DL so that the only remaining unknowns are the complex channel gains. These channel gains are estimated by radio devices using DL pilots and fed back to the radio unit. This method also requires feedback from radio device as does the conventional method; however, full channel knowledge can be obtained only by the transmission of 3P parameters, wherein P is the number of dominant paths, and 3 is the azimuth, elevation, and delay values for each path. For a massive MIMO base station with L antennas, it is necessary to transmit L different beams in DL to obtain full channel knowledge. Since L is much larger than 3P for sparse channels, this method significantly reduces the training overhead.

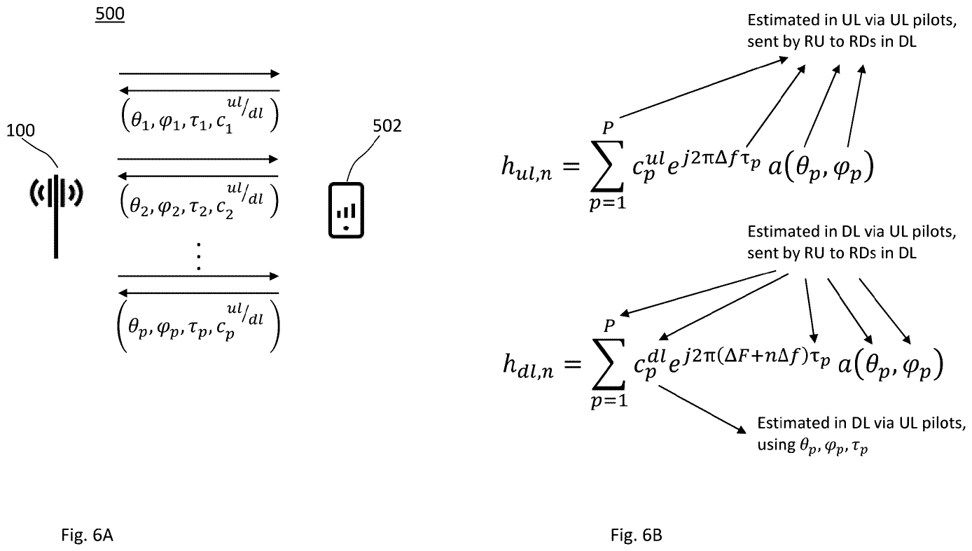

FIGS. 6A and 6B illustrate the UL-aided channel estimation for a single radio unit 100, wherein the three parameters for direction and delay are reciprocal, while the UL and DL complex channel gains are not reciprocal.

The radio unit 100 may use the received 302 UL pilot signals to measure 304 the number of paths (e.g., dominant paths), the angle of arrivals (e.g., azimuth and elevation) for each path, and the delays for each path. The radio unit 100 estimates 3P real numbers, where P is the number of paths (e.g., dominant paths).

The radio unit 100 may transmit 314 DL pilot signals, possibly with beamforming, to the radio devices 502 to determine complex path gains (e.g., path gain). The radio unit 100 may determine the P number of UL path gains and the 3P parameters by measuring the UL pilots received from the radio devices. The radio device 502 may determine the DL path gains by measuring the P number of DL pilots and based on the signaled 3 parameters associated with each of the P number of DL pilots. The radio unit 100 may transmit information symbols to inform radio device 502 of the 3P parameters estimated in UL phase.

The radio devices 502 may measure path gains (P complex numbers) by using DL pilots and 3P parameters transmitted by the radio unit 100. The radio devices 502 may transmit DL path gains in the UL phase to the radio unit 100 to estimate (e.g., compute) DL channel.

This technique may reduce DL training time as only 3P parameters are transmitted. Because per radio unit 100 and radio device 502, only P pilots and 3P parameters are transmitted in the DL, whereas in conventional methods L pilots and no parameters are transmitted in the DL for each radio unit 100 and radio device 502.

Some methods propose an UL-aided precoding for D-MIMO with FDD, without any training phase. Such methods completely remove the training overhead and the precoding may be designed using only angular information and large-scale fading coefficients of the dominant paths. Since the complex gains are not known at the side of the radio unit 100, the full performance cannot be achieved by this technique.

In the proposed method 300, the precoding may be designed using array steering vectors a_{m,k,p}∈ [symbol] ^{L×1} corresponding to the estimated arrival/departure angles and large-scale fading coefficients β_{m,k,p} of each dominant path. In method 300 it is assumed that a_{m,k,p} and β_{m,k,p} are estimated using UL pilot signals locally at radio units 100. It is worth to noting that although the angle and delay reciprocity in UL and DL are known, to construct a_{m,k,p} and β_{m,k,p} for DL may require conversions based on antenna array geometry (phase conversions for a_{m,k,p} and gain conversions for β_{m,k,p}), which are straightforward by using UL and DL carrier frequencies.

In literature there are multiple precoding types. For each m radio unit 100, the precoding coefficients w_{m,k}'s may be designed using a_{m,k,p} and β_{m,k,p} for k=1, 2, . . . , K and p=1, 2, . . . , P as
For example for angular maximum ratio transmission (MRT):

$${w}_{m , k} = \sqrt{{Q}_{t} {η}_{m , k}} {\sum }_{p = 1}^{P} \sqrt{{β}_{m , k , p}} {a}_{m , k , p}$$

For angular zero forcing (ZF):

$$\sqrt{{β}_{m , l , p}} {a}_{m , l , p} {w}_{m , k}^{′} = \{ \begin{matrix}1 , & if k = l \\ 0 , & otherwise\end{matrix} ∀ p = 1 , 2 , … , P$$

$${w}_{m , k} = \sqrt{{Q}_{t} {η}_{m , k}} {w}_{m , k}^{′}$$

Both above mentioned exemplary type of precoding apply local precoding operations where each radio unit 100 calculates its precoding coefficients independently. Furthermore, the complex gains

$$( {c}_{m , k , p}^{d l} )$$

of dominant paths are not known and hence not used in the precoding operations. Here Qₜ is the total transmit power of each radio unit 100, η_{m,k} is the power control coefficient for the pair m-th radio unit 100 and k-th radio device 502.

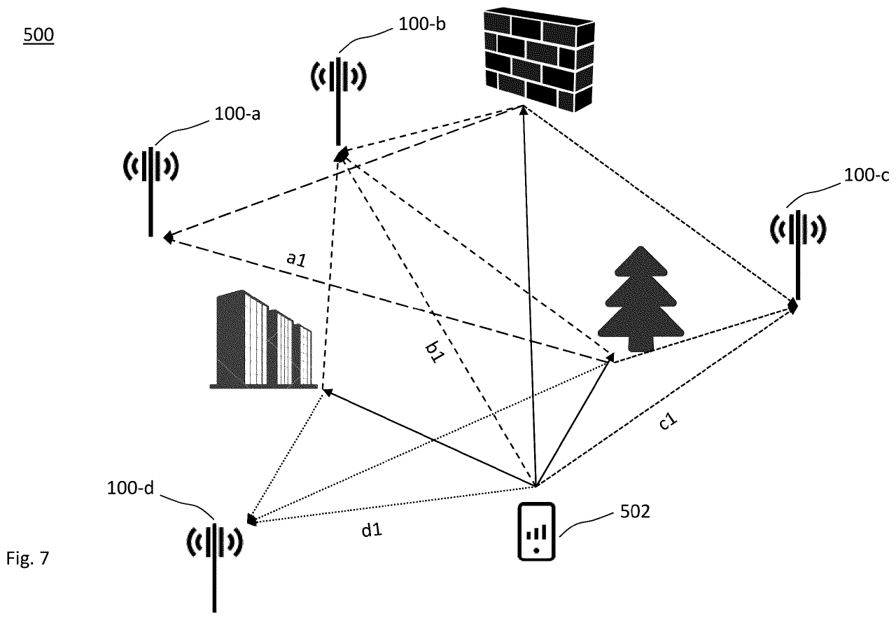

FIG. 7 schematically illustrates an example D-MIMO setup with different angle and delay parameters for multiple radio devices 100. FIG. 7 shows dominant paths from the radio device 502 to each of the radio units 100-a to 100-d. Among all dominant paths the top ranking (e.g., shortest path and/or delay) is labelled a1-d1. The multiple radio units 100-a to 100-d may not share the received 302 and processed (304-308) UL pilot information with each other. Therefore there may be dual connectivity and/or interference in the exemplary arrangement demonstrated. To eliminate such problem, the method 300 propose to receive a control message from a central unit 200 (which has an overview of the multiple radio units by being in communication with all of them).

The control message may be indicative of zero or more selected spatial layers towards the at least one radio device 502. The zero or more selected spatial layers are a subset of the one or more reported spatial layers. In this exemplary arrangement the radio unit 100-d may receive a control message indicative of the spatial layers towards the radio device 502, and all other radio units 100-a to 100-c may receive a control message indicative of zero selected spatial layers towards the radio device 502. The proposed method 300 provides the better connectivity, less interference, higher data rate transmission, faster handover (in case the radio device 502 is moving) and energy saving as compared to the prior art.

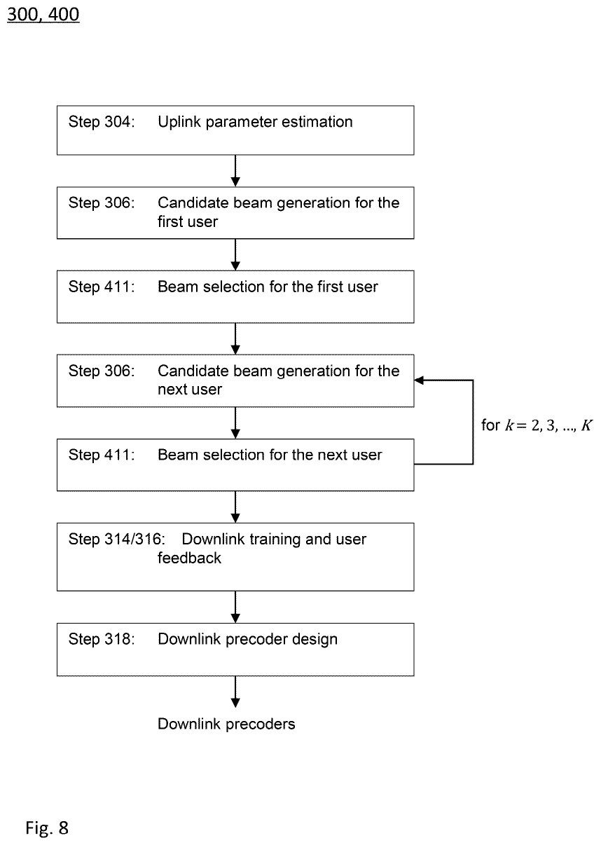

FIG. 8 shows a flowchart of an embodiment of the method 300 and 400.

In step 304, the UL-related parameters, such as at least one dominant path, azimuth and altitude angles, delays, gains, etc., are determined (e.g., estimated or extracted) by the radio unit 100 from the received 302 UL pilot signals.

In step 306, the radio unit 100 generates the one or more spatial layers. In other words the radio unit 100 generates some candidate beams. The radio unit 100 may use the estimated 304 UL parameters to generate candidate beams. The method 300 proposes an iterative algorithm for beam candidate generation 306.

In the first appearing step 306 in the FIG. 8 flowchart, each radio unit 100 may find an orthonormal basis

$${\{ {v}_{m , 1 , r} \}}_{r = 1}^{{R}_{m , 1}} for ℛ ( {\{ {a}_{m , 1 , p} \}}_{p = 1}^{P} )$$

and evaluate corresponding mean beam gains for the first radio device 502 (K=1, K is the index of the radio device 502 of the RAN) using the formula:

$${β}_{m , 1 , r}^{′} = {\sum }_{p = 1}^{P} {β}_{m , 1 , p} {\vert {a}_{m , 1 , p} {v}_{m , 1 , r}^{H} \vert}^{2} r = 1 , 2 , … , {R}_{m , 1} .$$

Here

$$ℛ ( {\{ {a}_{m , 1 , p} \}}_{p = 1}^{P} )$$

denotes the subspace spanned by the vectors

$${\{ {a}_{m , 1 , p} \}}_{p = 1}^{P} ,$$

R_{m,1} denotes the dimension of this subspace for the first user. The basis elements

$${\{ {v}_{m , 1 , r} \}}_{r = 1}^{{R}_{m , 1}}$$

are candidate beams determined by the m-th radio unit 100 for the first radio device 502 and

$${β}_{m , 1 , r}^{′}$$

values indicate their priorities.

The generated 306 candidate beams may be orthonormal (e.g., the scalar product of the candidate beams may be 1) complex-valued vectors based on beam subspaces of the radio units 100.

Each radio unit 100 may then transmit 310 a report message to the central unit 200. The report message may be indicative of

$${β}_{m , 1 , r}^{′}$$

values. As an example criterion, the largest P of the transmitted 310 report message may be selected 411 by the central unit 200 and the corresponding radio units 100 may be informed accordingly. The selected 411 beam vectors in the m-th radio unit 100 may be denoted as

$${\{ {v}_{m , 1 , j} \}}_{j = 1}^{{J}_{m , 1}} .$$

Here J_{m,1}≤R_{m,1} for all m since some of the candidate beams may not be selected by the central unit 200.

For k=2, 3, . . . , K (wherein k is the index of the radio device 502 of the RAN) the following steps 306 and 411 are repeated:

Each of the radio unit 100 finds and orthonormal basis for

$$𝒩 ( {\{ {v}_{m , ℓ , j} \}}_{1 \leq j \leq {J}_{m , ℓ} , 1 \leq ℓ \leq k - 1} ) ⋂ ℛ ( {\{ {a}_{m , k , p} \}}_{p = 1}^{P} )$$

where [symbol] are selected beam vectors of the m-th radio unit 100 up to this stage. In other words, for example, in the case of the K=2, the selected beam vectors would be the selected beam vectors towards the first radio device 502.

Here [symbol] ( [symbol] )denotes the null space of the vectors [symbol] ,i.e., it is the subspace including vectors that are orthogonal to all [symbol] .

Each radio unit 100 may further determine mean beam gains (i.e., priorities)

$${\{ {β}_{m , k , r}^{ℓ} \}}_{r = 1}^{{R}_{m , k}}$$

corresponding to each orthonormal basis vector using the formula:

$${β}_{m , 1 , r}^{′} = {\sum }_{p = 1}^{P} {β}_{m , k , p} {\vert {a}_{m , k , p} {v}_{m , k , r}^{H} \vert}^{2} r = 1 , 2 , … , {R}_{m , k} .$$

Here, v_{m,k,r}'s are the orthonormal basis vectors found and R_{m,k} is the dimension of their subspace.

These may be the conventional P dominant paths for the first radio device 502 (so M×P candidates for the first radio device 502 in total), for the further radio devices 502 P_{C} (e.g., P candidates) may be less than P due to the orthonormality condition.

The proposed method 300 comprises a step 306 in which beam candidates are generated by radio units 100 and selected 411 by central unit 200 for all radio devices 502 iteratively.

In the next appearing step 411 as in the first appearing step 411, the radio unit 100 for each radio device 502 transmits

$${β}_{m , k , r}^{′}$$

values to the central unit 200 and the largest P of them (as an exemplary selection criterion) may be selected and the radio units 100 are informed accordingly. The selected 411 beam vectors in the m-th radio unit 100 are denoted as

$${\{ {v}_{m , k , j} \}}_{j = 1}^{{J}_{m , k}} .$$

The steps 306 and 411 are repeated until all beams of the radio devices 502 are selected. The beam selection step 411 may be a necessary step to select beams at the central unit 200 using the beam priorities received 310 from the radio units 100.

The steps 306 and 411 include an iterative beam selection for radio devices 502. For each radio device 502 P beams may be selected, i.e.,

$${\sum }_{m = 1}^{M} {J}_{m , k} = P$$

for all k. For each radio unit 100, all selected beams may be unit-normal because they are selected from orthonormal basis vectors of some subspaces, and all selected beams are orthogonal to each other because each one is in the null-space of all previously selected beam vectors.

In step 306, a basis for intersection of two subspaces may be selected. It is important to note that if the total number of beams selected from radio unit 100 is less than P, then this intersection cannot be empty (e.g., there is always a beam to be selected). This can be demonstrated as follows:

The dimension of the subspace [symbol] ( [symbol] ) is equal to L−

$${\sum }_{ℓ = 1}^{k - 1} {J}_{m , ℓ} ,$$

where L is the maximum number of beams that can be generated by L antenna elements per radio unit 100, as they have

$${\sum }_{ℓ = 1}^{k - 1} {J}_{m , ℓ}$$

mutually orthogonal elements in [symbol] and they consider the null-space. The dimension of

$$ℛ ( {\{ {a}_{m , k , p} \}}_{p = 1}^{P} )$$

is equal to P when a non-ambiguous array geometry is chosen at radio units 100. A well-known theorem in linear algebra states that

$$dim ( {V}_{1} ⋂ {V}_{2} ) \geq dim ( {V}_{1} ) + dim ( {V}_{2} ) - L ,$$

wherein dim(·) stands for the dimension and V₁, V₂ are two subspaces of complex vectors in [symbol] ^{L×1}. Using this theorem, we obtain that

$$dim ( 𝒩 ( {\{ {v}_{m , ℓ , j} \}}_{1 \leq j \leq {J}_{m , ℓ} , 1 \leq ℓ \leq k - 1} ) ⋂ ℛ ( {\{ {a}_{m , k , p} \}}_{p = 1}^{P} ) ) \geq ( L - {\sum }_{ℓ = 1}^{k - 1} {J}_{m , ℓ} ) + P - L = P - {\sum }_{ℓ = 1}^{k - 1} {J}_{m , ℓ} .$$

The total number of beams selected from the m-th radio unit 100 before the k-th radio device 502 is equal to

$${\sum }_{ℓ = 1}^{k - 1} {J}_{m , ℓ}$$

and if it is less than P, we get

$$dim ( 𝒩 ( {\{ {v}_{m , ℓ , j} \}}_{1 \leq j \leq {J}_{m , ℓ} , 1 \leq ℓ \leq k - 1} ) ⋂ ℛ ( {\{ {a}_{m , k , p} \}}_{p = 1}^{P} ) ) \geq P - {\sum }_{ℓ = 1}^{k - 1} {J}_{m , ℓ} > 0 .$$

This result shows that each radio unit 100 may find at least one candidate beam if its total number of selected beams is less than P. Therefore, at least M×P candidate beams can be generated in total. Considering that there is a need for K×P beams in total, M>K is an enough condition to select all necessary beams. In a typical D-MIMO setup, M>>K and hence the step 306 and 411 can be completed without any stuck-in beam selection.

According to the step 308 of method 300, which is not shown in FIG. 8, the radio unit 100 may determine (e.g., compute) the beam priority. Embodiments of the method 300 allow computing the beam priorities using large-scale fading coefficients (e.g., statistical information) of each dominant path and corresponding generated candidate beams. Based on the measurement report, the central unit 200 may select the most prioritized beam for each radio device 502. Typically, the central unit 200 is in RAN (e.g., connected via frontal links to the radio units 100). Alternatively, the central unit 200 is implemented in the core network (CN).

Alternatively or in addition, the central unit 200 (instead of radio unit 100) may determine the beam priorities. In this case, the central unit 200 needs statistical information and array geometry for a steering vector (i.e., the vectors a_{m,k,p}) from radio devices 502. The β may be modified (weighted and projected to the orthonormal basis) to determine the priority.

The steps 314 and 316 relate to DL training using the selected 411 beams and DL pilots, and it also relate to feedback from the radio device 502 to the radio unit 100. In step 314 the radio unit 100 transmits beam-formed DL pilots to the at least one radio device 502. The P beams selected in steps 306 and 411 are used to transmit the DL pilots. In this phase, the selected beams 411 are transmitted 314 from the corresponding radio unit 100 using DL resources and DL pilots.

Each radio device 502 may measure the DL path gain of the corresponding effective channel. Then measured DL path gains may be quantized and fed back 316 to the radio unit 100. In this phase, each radio device 502 may measure corresponding complex channel gains

$${\{ {d}_{m , k , j} \}}_{j = 1}^{{J}_{m , k}}$$

and feed this information back 316 to the radio unit 100.

The training phase uses K×P DL resources as P beamformed DL pilots may be transmitted for each radio device 502. Each radio device 502 may measure P complex gain values and transmit 316 the measured values back to radio unit 100.

In step 318, the radio unit 100 may design (e.g., compute) precoding for the DL payload transmission. Designed precoding vectors may be formed by using a weighted sum of selected 411 beams. The weights may be determined using feedback 316 from the radio device 502 to the radio unit 100.

Each radio unit 100 may form its precoder as:

$${w}_{m , k} = \sqrt{{Q}_{t} {η}_{m , k}} {\sum }_{j = 1}^{{J}_{m , k}} {d}_{m , k , j}^{*} {v}_{m , k , j}^{H}$$

wherein Qₜ is the transmission power for each radio unit 100 and η_{m,k} is the power control coefficient for the pair m-th radio unit 100 and k-th radio device 502. The method 300 may suggest using the conjugate of the measured gain d_{m,k,j} to maximize the desired signal strength.

The radio unit 100 may select power control coefficients such that η_{m,k}=ηₘ for all k and

$${\sum }_{k = 1}^{K} 𝔼 [ \vert {w}_{m , k} {\vert}^{2} ] = {P}_{t} for all m .$$

In the step 318, the DL precoders are generated by a weighted sum of selected beams, the weights being determined by the feedback from the radio device 502.

It should be that the proposed method can be applicable for any power allocation method. In the proposed method, there is no specific power allocation method and therefore the power may be divided equally among the radio devices 502.

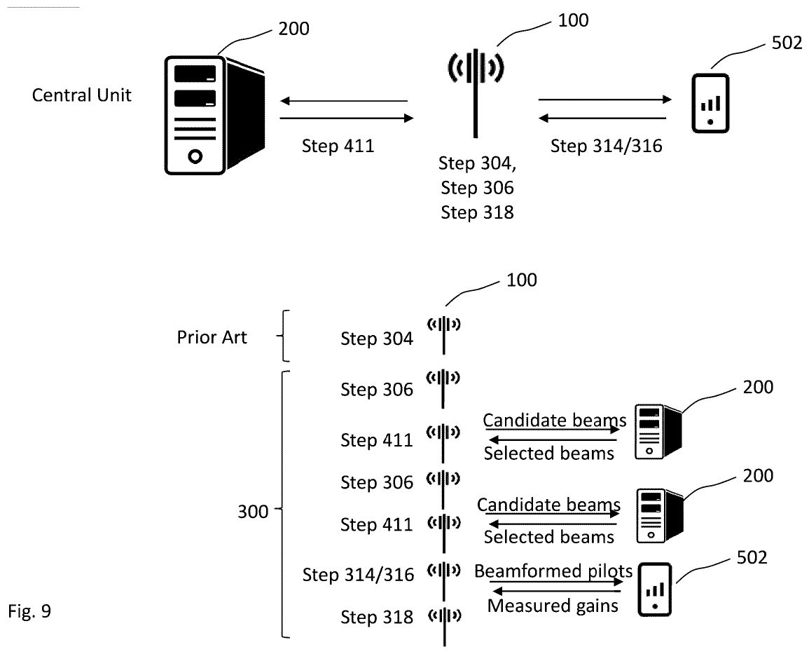

FIG. 9 shows another exemplary flowchart and model of the proposed method according to FIGS. 3A to 4. In FIG. 9, the flowchart of the proposed method 300 is given. The step 304 may be the initial step. The method steps 306 and 318 involve calculations performed locally at the radio unit 100. Step 411 comprises fronthaul transmission/reception with the central unit 200. The steps 314/316 comprise DL pilot transmission to radio device 502 and radio device 502 feedback received by radio unit 100 in UL.

As shown in FIG. 7, the proposed method 300 requires additional signaling between the radio unit 100 and the central unit 200 (e.g., over fronthaul links) and a feedback mechanism between the radio unit 100 and the radio device 502 (e.g., over access links).

The proposed method significantly reduces the overhead in the training stage, for example by using orthonormal precoding vectors at each radio unit 100, such that each precoding vector may be an element of the range space formed by the array steering vectors of the corresponding radio device 502. The method 300 may select P different beams (e.g., assuming the same or maximum number of paths for each radio unit 100) in total for each radio device 502 (where the system comprises K radio device 502 in total), and thus the total DL resource required for training is equal to K×P. The conventional P dominant paths per radio unit 100 for one radio device 502 include paths that may coincide from the perspective of the radio device 502.

Each radio unit 100 may determine some candidate beams P_{C} according to the information obtained in the UL from the radio device 502. A priority metric may be calculated for each candidate beam P_{C} and sent by each radio unit 100 to a central unit 200. The central unit 200 may select the (P≤P_{C}) final beams according to the priorities and/or some other criteria. This stage may be performed iteratively for all the radio devices 502.

After beam selection is completed for all radio devices 502, the training stage begins and selected beams are transmitted via DL pilots. The radio devices 502 estimate the complex gains (e.g., DL path gain) of the effective channels using the DL pilots and feed back the associated gains in UL stage.

Finally, precoders may be formed by radio units 100 using weighted sums of beam vectors, the weights being calculated using channel feedback from radio device 502.

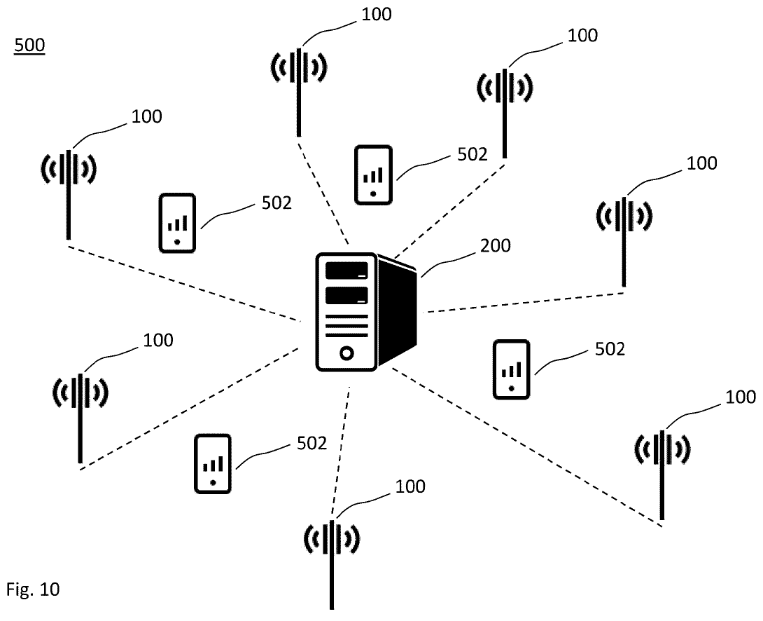

FIG. 10 schematically illustrates a D-MIMO system 500, i.e. an example topology. It is shown by way of example that radio units 100 may be distributed, jointly serving multiple radio devices 502 in the same time/frequency resource block. All radio units 100 may communicate with a central unit 200 (e.g., via fronthaul links). Some network operations may be performed at the central unit 200 to optimize the performance by jointly processing data from all radio units 100, and some other operations may be performed locally at the radio units 100 to minimize the data rates between the central unit 200 and one or more radio units 100, and to minimize the information exchange overhead.

The proposed method may use UL information obtained by UL pilots from radio devices 502 within the radio unit 100. The initial step 302 may be performed by the radio unit 100 to collect the necessary UL data.

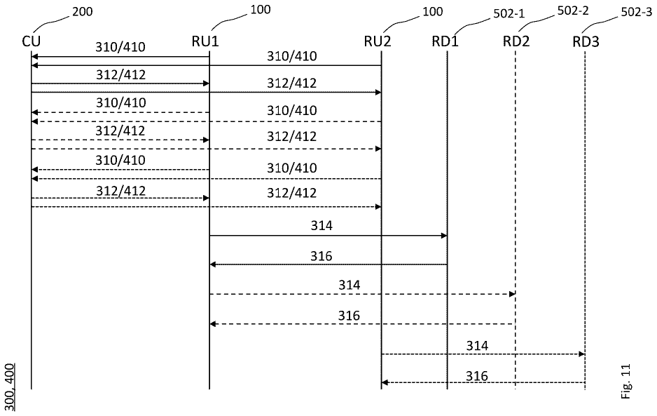

FIG. 11 shows a schematic signaling diagram resulting from embodiments of the multiple radio unit 100 and a central unit 200 performing implementations of the methods 300 and 400.

FIG. 11 shows the methods 300 and 400 performed iteratively over all of the radio devices 502 (here each line style corresponds to a radio device 502). The radio unit 100 may receive 312 a control message from the central unit 200 indicative of the selected spatial layers. For example, radio unit 100-1 may receive a control message indicative of the selected spatial layer towards the radio devices 502-1 and 502-2, and zero selected spatial layer towards the radio device 502-3. The radio unit 100-2 may receive a control message indicative of the selected spatial layer towards the radio device 502-3, and zero selected spatial layer towards the radio devices 502-1 and 502-2.

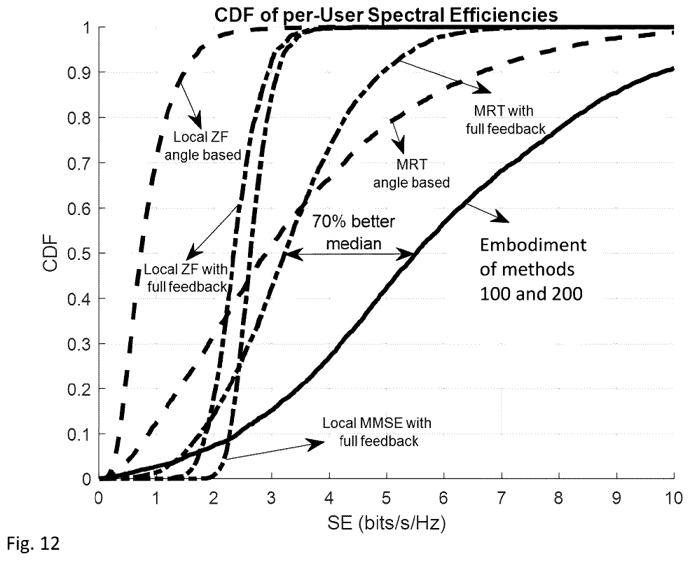

FIG. 12 schematically illustrates a diagram of cumulative distribution functions (CDFs) as a function of spectral efficiencies (SE) per radio device 502 for different precoding methods.

FIG. 12 shows the spectral efficiencies (SE) per radio device 502 (e.g., per UE) of the state of the art and the methods 300 and 400 described and analyzed herein. According to the results, embodiments of the methods 300 and 400 can achieve at least 70% better median spectral efficiency compared to all other baseline techniques. Furthermore, the CDF curve indicates that the user spectral efficiencies are greater than 2.3 bps/Hz with 90% probability, showing the effectiveness of the proposed method 300.

The proposed method 300 has a low training overhead (because P<<M×P). The training requires K×P DL resources which is much smaller than the value (M×K×P) required for the conventional method in the D-MIMO setup with many radio units 100. Furthermore, the training overhead is independent of the number of radio units 100, which makes the solution scalable.

Since the training overhead is taken into account in the DL payload transmission, the proposed method 300 has significantly better performance than the conventional method and the angular precoding proposed in some prior art methods.

The numerical results show that the proposed method 300 has at least 70% better median spectral efficiency per radio device 502 than all other reference methods (i.e., prior art methods or baseline methods).

In the proposed method 300, all signal processing is performed locally at the radio unit 100 using only local information. The only centralized part relates to beam selection from candidate beams. This operation requires the transmission of a few priority values of beams (e.g., over fronthaul links) to the central unit 200, which is negligible.

By means of the iterative beam selection in the proposed method 300, when a new radio device 502 is scheduled for a time/frequency resource block, the precoding for the new radio device 502 may be calculated directly without changing or recalculating the precoders of the already existing radio devices 502.

Some numerical results are shown for the state of the art and for the proposed method 300 are shown below.

Various simulations have been carried out to show the advantages of the proposed solution 300 in terms of spectral efficiency. In the simulation the radio units 100 and the radio devices 502 are randomly distributed in a square area. The simulation parameters are given in Table I.

TABLE I
The simulation parameters

| The number of RUs (M) | 16 | |
|---|---|---|
| The number of UEs (K) | 4 | |
| The number of RU antennas (L) | 8 | |
| The number of UE antennas | 1 | |
| RU antenna array geometry | 2 × 4 rectangular with half- | |
| | wavelength element spacing | |
| Frequency (ƒ) | 6 | GHz |
| Bandwidth | 20 | MHz |
| The number of dominant | 3 | |
| paths (P) | | |
| The side-length of the | 500 | m |
| square area (D) | | |
| The total per-RU transmit power | 0.2 | W |

| | |
|---|---|
| The coherence block length (τ_{c}) | 400 |

P and τ_{c} have been chosen considering the information below:
1) S. Kim, J. W. Choi and B. Shim, “Downlink Pilot Precoding and Compressed Channel Feedback for FDD-Based Cell-Free Systems,” in IEEE Transactions on Wireless Communications, vol. 19, no. 6, pp. 3658-3672 June 2020, give the number of dominant paths as

$$P = \{ \begin{matrix}10 \sim 20 , for f < 6 GHz \\ 2 \sim 8 , for 6 < f < 60 GHz\end{matrix}$$

2) A rule-of-thumb coherence time and coherence bandwidth calculations are given by

$${T}_{c} = \frac{λ}{4 v} , {B}_{c} = \frac{1}{2 {T}_{d}} ,$$

wherein λ is the wavelength, v is the user speed, T_{d} is the delay spread. For 6 GHz carrier frequency, 5 m/s user speed and 3 μs delay spread (a typical value for outdoor), we obtain

$${τ}_{c} = {T}_{c} {B}_{c} = 2.5 ms \times 167 kHz \approx 417 .$$

In the simulations, 6 different precoding types are compared. Three of them are related to the conventional technique and two of them are proposed by A. Abdallah and M. M. Mansour, “Efficient Angle-Domain Processing for FDD-Based Cell-Free Massive MIMO Systems,” in IEEE Transactions on Communications, vol. 68, no. 4, pp. 2188-223 April 2020.

MRT with full feedback: Maximal ratio transmission precoding is applied where the full channel knowledge is obtained using conventional technique. This method locally implements conjugate beamforming at each radio unit 100.

Local ZF with full feedback: Local zero-forcing precoding is applied where the full channel knowledge is obtained using conventional technique. This method aims at eliminating the inter-user (e.g., radio device 502) interference at each radio unit 100 locally.

Local MMSE with full feedback: Local minimum mean-square error precoding is applied where the full channel knowledge is obtained using conventional technique. This method aims at eliminating both the inter-user (e.g., radio device 502) interference and noise at each radio unit 100 locally.

Angular MRT: Maximal ratio transmission precoding is applied using the angle/delay information obtained by UL information.

Angular ZF: Local zero-forcing precoding is applied using the angle/delay information obtained by UL information.

Angular MRT and angular ZF are proposed by A. Abdallah and M. M. Mansour, “Efficient Angle-Domain Processing for FDD-Based Cell-Free Massive MIMO Systems,” in IEEE Transactions on Communications, vol. 68, no. 4, pp. 2188-223 April 2020, and the details are given in background.

Spectral efficiencies (SE) may be determined per radio device 502 (or user) using the formulas:

$$SIN {R}_{k} = \frac{{\vert {\sum }_{m = 1}^{M} {h}_{m , k} {w}_{m , k} \vert}^{2}}{𝔼 [ {\sum }_{ℓ \neq k}^{K} {\vert {\sum }_{m = 1}^{M} {h}_{m , k} {w}_{m , ℓ} \vert}^{2} ] + {σ}_{k}^{2}} and$$

$${SE}_{k} = \frac{{τ}_{c} - {τ}_{p}}{{τ}_{c}} 𝔼 [ {log}_{2} ( 1 + SIN {R}_{k} ) ] ,$$

wherein h_{m,k} is the DL channel, and w_{m,k} is the designed precoder for the pair m-th radio unit 100 and k-th radio device 502. [symbol] [·] is the expectation operator

$${σ}_{k}^{2}$$

is the noise power of UE k. τ_{c} is the channel coherence block length and τₚ is the DL pilot length given in Table II.

TABLE II
Downlink pilot length (τₚ) values for different precoding types

| Angle-based precoding | Full-CSI precoding | Proposed |
|---|---|---|
| 0 | MKP | KP |

Each of the radio units 100 may be a network node or a base station. Herein, any radio device may be a mobile or portable station and/or any radio device wirelessly connectable to a base station or RAN, or to another radio device. For example, the radio device may be a user equipment (UE), a device for machine-type communication (MTC) or a device for (e.g., narrowband) Internet of Things (IoT). Furthermore, any base station may be a station providing radio access, may be part of a radio access network (RAN) and/or may be a node connected to the RAN for controlling the radio access. For example, the base station may be an access point, for example a Wi-Fi access point.

Herein, whenever referring to noise or a signal-to-noise ratio (SNR), a corresponding step, feature or effect is also disclosed for noise and/or interference or a signal-to-interference-and-noise ratio (SINR), and vice versa.

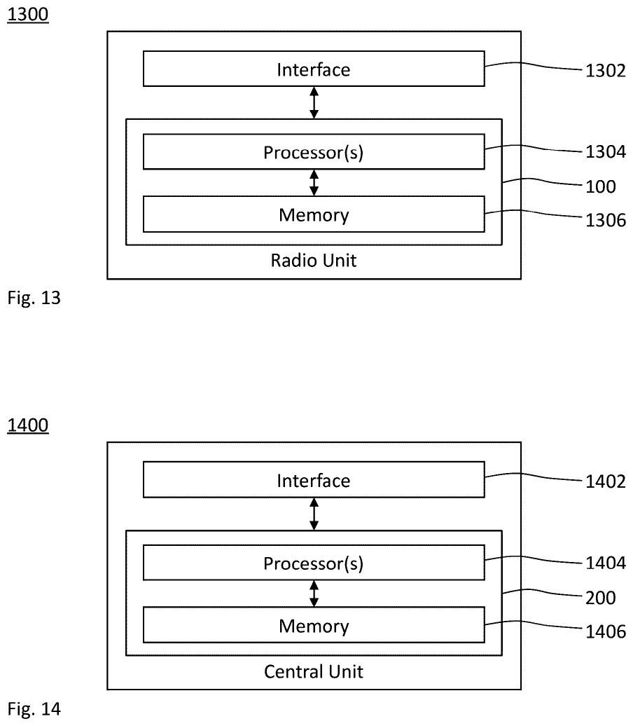

FIG. 13 shows a schematic block diagram for an embodiment of the device 100. The device 100 comprises processing circuitry, e.g., one or more processors 1304 for performing the method 300 and memory 1306 coupled to the processors 1304. For example, the memory 1306 may be encoded with instructions that implement at least one of the modules 102, 104 and 106.

The one or more processors 1304 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 1306, radio unit or base station functionality of the RAN. For example, the one or more processors 1304 may execute instructions stored in the memory 1306. Such functionality may include providing various features and steps discussed herein, including any of the benefits disclosed herein. The expression “the device being operative to perform an action” may denote the device 100 being configured to perform the action.

As schematically illustrated in FIG. 13, the device 100 may be embodied by a radio unit (RU) 1300, e.g., functioning as a base station (e.g., a gNB). The RU 1300 comprises a radio interface 1302 coupled to the device 100 for radio communication with one or more radio devices, e.g., functioning as UEs and/or a wired or wireless interface 1302 coupled to the device 100 for communication with an embodiment of the central unit 200.

FIG. 14 shows a schematic block diagram for an embodiment of the device 200. The device 200 comprises processing circuitry, e.g., one or more processors 1404 for performing the method 400 and memory 1406 coupled to the processors 1404. For example, the memory 1406 may be encoded with instructions that implement at least one of the modules 202, 204 and 206.

The one or more processors 1404 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 200, such as the memory 1406, central unit (e.g., central processor) functionality. For example, the one or more processors 1404 may execute instructions stored in the memory 1406. Such functionality may include providing various features and steps discussed herein, including any of the benefits disclosed herein. The expression “the device being operative to perform an action” may denote the device 200 being configured to perform the action.

As schematically illustrated in FIG. 14, the device 200 may be embodied by a central unit (CU) 1400, e.g., functioning as a coordinating node in the RAN or core network (CN). The CU 1400 comprises an interface 1402 coupled to the device 200 for communication with at least two RUs 100, e.g., functioning as base stations of the RAN.

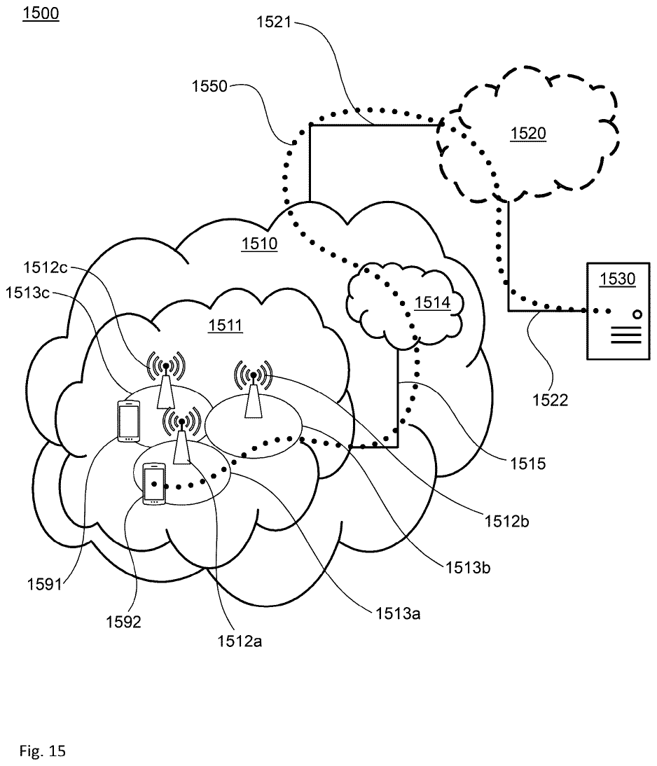

With reference to FIG. 15, in accordance with an embodiment, a communication system 1500 includes a telecommunication network 1510, such as a 3GPP-type cellular network, which comprises an access network 1511, such as a radio access network, and a core network 1514. The access network 1511 comprises a plurality of base stations 1512a, 1512b, 1512c, such as NBs, eNBs, gNBs or other types of wireless access points, each defining a corresponding coverage area 1513a, 1513b, 1513c. Each base station 1512a, 1512b, 1512c is connectable to the core network 1514 over a wired or wireless connection 1515. A first user equipment (UE) 1591 located in coverage area 1513c is configured to wirelessly connect to, or be paged by, the corresponding base station 1512c. A second UE 1592 in coverage area 1513a is wirelessly connectable to the corresponding base station 1512a. While a plurality of UEs 1591, 1592 are illustrated in this example, the disclosed embodiments are equally applicable to a situation where a sole UE is in the coverage area or where a sole UE is connecting to the corresponding base station 1512.

Any of the base stations 1512 may embody the device 100 or 200. Alternatively or in addition, any one of the core network 1514, the intermediate network 1520 or the host computer 1530 may embody the device 200.

The telecommunication network 1510 is itself connected to a host computer 1530, which may be embodied in the hardware and/or software of a standalone server, a cloud-implemented server, a distributed server or as processing resources in a server farm. The host computer 1530 may be under the ownership or control of a service provider, or may be operated by the service provider or on behalf of the service provider. The connections 1521, 1522 between the telecommunication network 1510 and the host computer 1530 may extend directly from the core network 1514 to the host computer 1530 or may go via an optional intermediate network 1520. The intermediate network 1520 may be one of, or a combination of more than one of, a public, private or hosted network; the intermediate network 1520, if any, may be a backbone network or the Internet; in particular, the intermediate network 1520 may comprise two or more sub-networks (not shown).

The communication system 1500 of FIG. 15 as a whole enables connectivity between one of the connected UEs 1591, 1592 and the host computer 1530. The connectivity may be described as an over-the-top (OTT) connection 1550. The host computer 1530 and the connected UEs 1591, 1592 are configured to communicate data and/or signaling via the OTT connection 1550, using the access network 1511, the core network 1514, any intermediate network 1520 and possible further infrastructure (not shown) as intermediaries. The OTT connection 1550 may be transparent in the sense that the participating communication devices through which the OTT connection 1550 passes are unaware of routing of uplink and downlink communications. For example, a base station 1512 need not be informed about the past routing of an incoming downlink communication with data originating from a host computer 1530 to be forwarded (e.g., handed over) to a connected UE 1591. Similarly, the base station 1512 need not be aware of the future routing of an outgoing uplink communication originating from the UE 1591 towards the host computer 1530.

By virtue of the method 300 being performed by any one of the base station 1512 and/or the method 400 by any one of the nodes 1514, 1520 or 1530, the performance or range of the OTT connection 1550 can be improved, e.g., in terms of increased throughput and/or reduced latency. More specifically, the host computer 1530 may indicate to the system 500 or the central unit 200 or the radio unit 100 (e.g., on an application layer) a QoS of the payload or user data, which may trigger performing the methods 300 and 400.

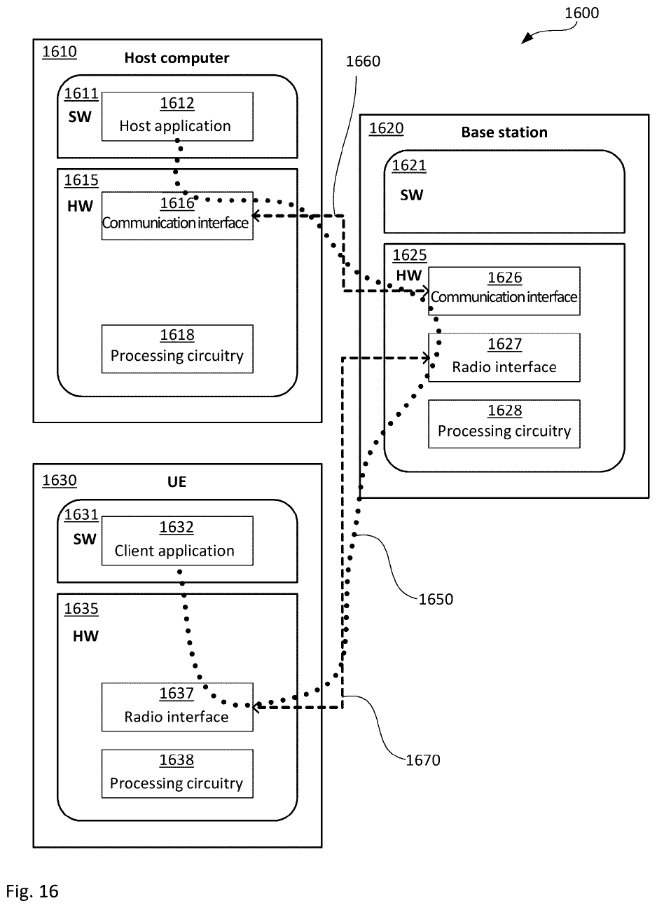

Example implementations, in accordance with an embodiment of the UE, base station and host computer discussed in the preceding paragraphs, will now be described with reference to FIG. 16. In a communication system 1600, a host computer 1610 comprises hardware 1615 including a communication interface 1616 configured to set up and maintain a wired or wireless connection with an interface of a different communication device of the communication system 1600. The host computer 1610 further comprises processing circuitry 1618, which may have storage and/or processing capabilities. In particular, the processing circuitry 1618 may comprise one or more programmable processors, application-specific integrated circuits, field programmable gate arrays or combinations of these (not shown) adapted to execute instructions. The host computer 1610 further comprises software 1611, which is stored in or accessible by the host computer 1610 and executable by the processing circuitry 1618. The software 1611 includes a host application 1612. The host application 1612 may be operable to provide a service to a remote user, such as a UE 1630 connecting via an OTT connection 1650 terminating at the UE 1630 and the host computer 1610. In providing the service to the remote user, the host application 1612 may provide user data, which is transmitted using the OTT connection 1650. The user data may depend on the location of the UE 1630. The user data may comprise auxiliary information or precision advertisements (also: ads) delivered to the UE 1630. The location may be reported by the UE 1630 to the host computer, e.g., using the OTT connection 1650, and/or by the base station 1620, e.g., using a connection 1660.

The communication system 1600 further includes a base station 1620 provided in a telecommunication system and comprising hardware 1625 enabling it to communicate with the host computer 1610 and with the UE 1630. The hardware 1625 may include a communication interface 1626 for setting up and maintaining a wired or wireless connection with an interface of a different communication device of the communication system 1600, as well as a radio interface 1627 for setting up and maintaining at least a wireless connection 1670 with a UE 1630 located in a coverage area (not shown in FIG. 16) served by the base station 1620. The communication interface 1626 may be configured to facilitate a connection 1660 to the host computer 1610. The connection 1660 may be direct, or it may pass through a core network (not shown in FIG. 16) of the telecommunication system and/or through one or more intermediate networks outside the telecommunication system. In the embodiment shown, the hardware 1625 of the base station 1620 further includes processing circuitry 1628, which may comprise one or more programmable processors, application-specific integrated circuits, field programmable gate arrays or combinations of these (not shown) adapted to execute instructions. The base station 1620 further has software 1621 stored internally or accessible via an external connection.

The communication system 1600 further includes the UE 1630 already referred to. Its hardware 1635 may include a radio interface 1637 configured to set up and maintain a wireless connection 1670 with a base station serving a coverage area in which the UE 1630 is currently located. The hardware 1635 of the UE 1630 further includes processing circuitry 1638, which may comprise one or more programmable processors, application-specific integrated circuits, field programmable gate arrays or combinations of these (not shown) adapted to execute instructions. The UE 1630 further comprises software 1631, which is stored in or accessible by the UE 1630 and executable by the processing circuitry 1638. The software 1631 includes a client application 1632. The client application 1632 may be operable to provide a service to a human or non-human user via the UE 1630, with the support of the host computer 1610. In the host computer 1610, an executing host application 1612 may communicate with the executing client application 1632 via the OTT connection 1650 terminating at the UE 1630 and the host computer 1610. In providing the service to the user, the client application 1632 may receive request data from the host application 1612 and provide user data in response to the request data. The OTT connection 1650 may transfer both the request data and the user data. The client application 1632 may interact with the user to generate the user data that it provides.

It is noted that the host computer 1610, base station 1620 and UE 1630 illustrated in FIG. 16 may be identical to the host computer 1530, one of the base stations 1512a, 1512b, 1512c and one of the UEs 1591, 1592 of FIG. 15, respectively. This is to say, the inner workings of these entities may be as shown in FIG. 16, and, independently, the surrounding network topology may be that of FIG. 15.

In FIG. 16, the OTT connection 1650 has been drawn abstractly to illustrate the communication between the host computer 1610 and the UE 1630 via the base station 1620, without explicit reference to any intermediary devices and the precise routing of messages via these devices. Network infrastructure may determine the routing, which it may be configured to hide from the UE 1630 or from the service provider operating the host computer 1610, or both. While the OTT connection 1650 is active, the network infrastructure may further take decisions by which it dynamically changes the routing (e.g., on the basis of load balancing consideration or reconfiguration of the network).

The wireless connection 1670 between the UE 1630 and the base station 1620 is in accordance with the teachings of the embodiments described throughout this disclosure. One or more of the various embodiments improve the performance of OTT services provided to the UE 1630 using the OTT connection 1650, in which the wireless connection 1670 forms the last segment. More precisely, the teachings of these embodiments may reduce the latency and improve the data rate and thereby provide benefits such as better responsiveness and improved QoS.

A measurement procedure may be provided for the purpose of monitoring data rate, latency, QoS and other factors on which the one or more embodiments improve. There may further be an optional network functionality for reconfiguring the OTT connection 1650 between the host computer 1610 and UE 1630, in response to variations in the measurement results. The measurement procedure and/or the network functionality for reconfiguring the OTT connection 1650 may be implemented in the software 1611 of the host computer 1610 or in the software 1631 of the UE 1630, or both. In embodiments, sensors (not shown) may be deployed in or in association with communication devices through which the OTT connection 1650 passes; the sensors may participate in the measurement procedure by supplying values of the monitored quantities exemplified above, or supplying values of other physical quantities from which software 1611, 1631 may compute or estimate the monitored quantities. The reconfiguring of the OTT connection 1650 may include message format, retransmission settings, preferred routing etc.; the reconfiguring need not affect the base station 1620, and it may be unknown or imperceptible to the base station 1620. Such procedures and functionalities may be known and practiced in the art. In certain embodiments, measurements may involve proprietary UE signaling facilitating the host computer's 1610 measurements of throughput, propagation times, latency and the like. The measurements may be implemented in that the software 1611, 1631 causes messages to be transmitted, in particular empty or “dummy” messages, using the OTT connection 1650 while it monitors propagation times, errors etc.

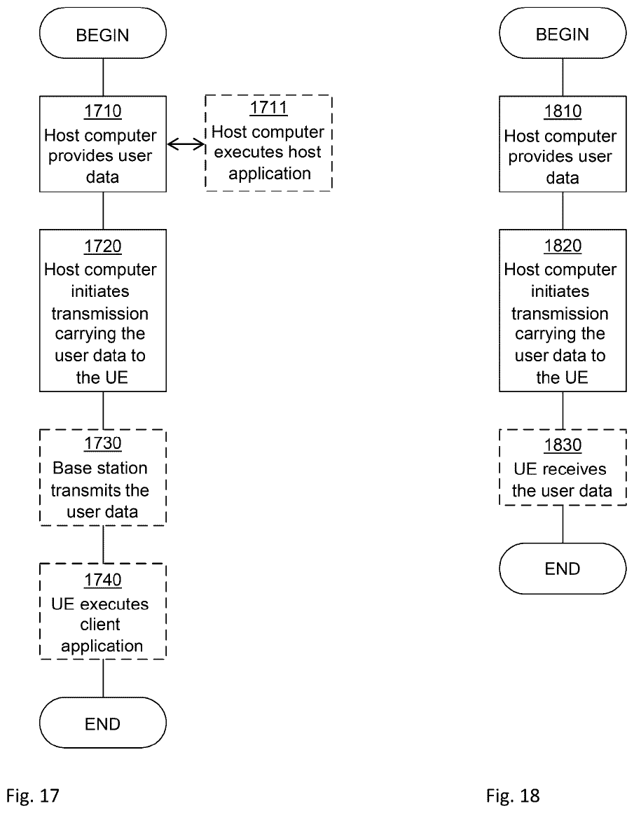

FIG. 17 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 17 will be included in this paragraph. In a first step 1710 of the method, the host computer provides user data. In an optional substep 1711 of the first step 1710, the host computer provides the user data by executing a host application. In a second step 1720, the host computer initiates a transmission carrying the user data to the UE. In an optional third step 1730, the base station transmits to the UE the user data which was carried in the transmission that the host computer initiated, in accordance with the teachings of the embodiments described throughout this disclosure. In an optional fourth step 1740, the UE executes a client application associated with the host application executed by the host computer.

FIG. 18 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 18 will be included in this paragraph. In a first step 1810 of the method, the host computer provides user data. In an optional substep (not shown) the host computer provides the user data by executing a host application. In a second step 1820, the host computer initiates a transmission carrying the user data to the UE. The transmission may pass via the base station, in accordance with the teachings of the embodiments described throughout this disclosure. In an optional third step 1830, the UE receives the user data carried in the transmission.

Abbreviation used herein have the meaning as defined above or indicated below.

| Abbreviation | Explanation |
|---|---|
| CDF | Cumulative distribution function |
| D-MIMO | Distributed Multiple-Input |
| | Multiple-Output |
| FDD | Frequency division duplex |
| MMSE | Minimum mean-square error |
| MRT | Maximal ratio transmission |
| RU | Radio Unit |
| SE | Spectral efficiency |
| SINR | Signal-to-interference-and-noise-ratio |
| TDD | Time division duplex |
| UE | User equipment |
| ZF | Zero-forcing |

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following claims.

1. A method (300) performed by a radio unit, RU, of a radio access network, RAN, the method comprising:
sending a report message to a central unit, CU, of the RAN, wherein the report message is indicative of a priority value for each of one or more reported spatial layers towards at least one radio device; and
receiving a control message from the CU, wherein the control message is indicative of zero or more selected spatial layers towards the at least one radio device, wherein the zero or more selected spatial layers are a subset of the one or more reported spatial layers.

2. The method of claim 1, wherein the report message is indicative of each of the at least one radio device in association with each of the one or more reported spatial layers towards the at least one radio device.

3. The method of claim 1, wherein the RAN comprises a plurality of RUs for distributed multiple-input multiple-output, D-MIMO, in the downlink, DL, to the at least one radio device.

4. The method of claim 1, further comprising or initiating:
receiving an uplink, UL, pilot signal from the at least one radio device.

5. The method of claim 4, further comprising:
determining the priority value for each of the one or more reported spatial layers towards the at least one radio device based on the UL pilot signal received from a respective one of the at least one radio device.

6. The method of claim 5, further comprising:
measuring at least one dominant path for each of the at least one radio device based on the UL pilot signal received from the respective one of the at least one radio device, wherein each of the at least one dominant path corresponds to:
a beam direction of a radio beam at the RU towards the respective one of the at least one radio device or a propagation delay of a radio propagation between the RU and the respective one of the at least one radio device, and
a path gain between the RU and the respective one of the at least one radio device; and
generating the one or more reported spatial layers, wherein the one or more reported spatial layers correspond to a linear combination of the measured one or more dominant paths, and the priority value for each of the one or more reported spatial layers is determined by said linear combination of a square of the path gain of the measured one or more dominant paths.

7. The method of claim 6, wherein precoding vectors of the reported spatial layers are orthonormal according to a standard inner product and/or as a result of the linear combination.

8. The method of claim 6, wherein precoding vectors of the reported spatial layers towards the same radio device are orthonormal according to a standard inner product or as a result of the linear combination.

9. The method of claim 6, wherein any precoding vector of the reported spatial layers towards a first radio device is orthonormal to any precoding vector of the reported spatial layers towards a second radio device according to a standard inner product or as a result of the linear combination.

10. The method of claim 1, further comprising or initiating:
transmitting a downlink, DL, pilot signal to the at least one radio device using the at least one selected spatial layer received from the CU, or
refraining from transmitting to one of the at least one radio device if the received control message is indicative of no selected spatial layers towards the respective one of the at least one radio device.

11. The method of claim 10, wherein subcarriers for receiving an uplink, UL, pilot signal from the at least one radio device are separated in the frequency domain from subcarriers for transmitting the DL pilot signal according to frequency division duplex, FDD.

12. The method of claim 10, further comprising:
receiving from the at least one radio device a channel state report based on the DL pilot signal, the channel state report comprising at least one of:
a measured DL gain of the one or more selected spatial layers;
a precoding vector or precoding matrix of the one or more selected spatial layers;
a codebook index for a precoding vector or precoding matrix of the one or more selected spatial layers; and
a channel state information, CSI, report of the one or more selected spatial layers.

13. The method of claim 12, wherein the method further comprising:
computing a DL precoder based on the channel state report received from the at least one radio device.

14. The method of claim 13, further comprising:
transmitting payload data to the at least one radio device using the DL precoder based on the selected spatial layers received from the CU and the channel state report received from the at least one radio device.

15. The method of claim 1, wherein the RU is in radio communication with a plurality of radio devices, and
wherein the generating the reported spatial layers or the determining the priority values for each of the reported spatial layers or sending the report message or the receiving the selected spatial layers are performed iteratively for all the radio devices in radio communication with the RU.

16. The method of claim 1, further comprising:
transmitting payload data using a weighted sum of the selected spatial layers towards the at least one radio device, optionally without precoding of the selected spatial layers towards the at least one radio device.

17. The method of claim 16, wherein the weights of the selected spatial layers per radio device is based on
a signal-to-interference and noise ratio, SINR, or
a sounding reference signal, SRS, or
a channel state information, CSI, report
received at the RU.

18. A method performed by a central unit, CU of a radio access network, RAN, the method comprising:
receiving a report message from at least two radio units, RUs, of the RAN, wherein the report message is indicative of a priority value for each of one or more reported spatial layers towards at least one radio device; and
sending a control message to each of the at least two RUs, wherein the control message is indicative of zero or more selected spatial layers towards the at least one radio device, wherein the zero or more selected spatial layers are a subset of the one or more reported spatial layers.

19. The method of claim 18, further comprising:
selecting zero or more spatial layers towards the at least one radio device from the received at least one priority value for each of the one or more reported spatial layers towards at least one radio device.

20-22. (canceled)

23. A radio unit, RU, of a radio access network, RAN, the RU being configured to:
send a report message to a central unit, CU, of the RAN, wherein the report message is indicative of a priority value for each of one or more reported spatial layers towards at least one radio device; and
receive a control message from the CU, wherein the control message is indicative of zero or more selected spatial layers towards the at least one radio device, wherein the zero or more selected spatial layers are a subset of the one or more reported spatial layers.

24-29. (canceled)
